(19) United States
(12) Patent Application Publication
(10) Pub. No.: US 2017/0150464 A1
(43) Pub. Date: May 25, 2017

(54) COMMUNICATION APPARATUS, TIME SYNCHRONIZING METHOD, AND NON-TRANSITORY COMPUTER-READABLE STORAGE MEDIUM

(71) Applicant: FUJITSU LIMITED, Kawasaki-shi (JP)

(72) Inventors: Kenji KAZEHAYA, Yokohama (JP); Shigeaki KAWAMATA, Sagamihara (JP); Yuichiro KATAGIRI, lnagi (JP); Masumi KOBAYASHI, Kawasaki (JP)

(21) Appl. No.: 15/288,639

(22) Filed: Oct. 7, 2016

(30) Foreign Application Priority Data
Nov. 20, 2015 (JP) 2015-227665

(51) Int. Cl. H04W 56/00; H04L 12/42; H04B 7/26

(52) U.S. Cl. CPC H04W 56/0015; H04B 7/269; H04L 12/422; H04L 5/1469

(57) ABSTRACT

A communication apparatus, for relaying a time synchronizing signal between a master and a slave that transmit PTP (Precision Time Protocol) signals, stores a first time of the communication apparatus at a point in time that the communication apparatus receives a first time synchronizing signal addressed to the slave, obtains a second time of the master at a point in time that the first time synchronizing signal is transmitted from the master, from the first time synchronizing signal or the like, obtains an amount of offset that is a difference between a reference time of the master and a reference time of the communication apparatus, using the first time as a time of the slave and the second time as the time of the master in a time synchronizing algorithm of the PTP, and corrects the reference time of the communication apparatus using the amount of offset.

### CROSS-REFERENCE TO RELATED APPLICATION

This application is based upon and claims the benefit of priority of the prior Japanese Patent Application No. 2015-227665, filed on Nov. 20, 2015, the entire contents of which are incorporated herein by reference.

### FIELD

The embodiments discussed herein are related to a communication apparatus, a time synchronizing method, and a non-transitory computer-readable storage medium.

### BACKGROUND

As one of radio base station devices, there is a radio base station device including a baseband unit (Base Band Unit: BBU) and a radio unit (Remote Radio Head: RRH) coupled to the BBU. The BBU is coupled to one or more BBUs via a general-purpose interface of the Open Base Station Architecture Initiative (OBSAI), the Common Public Radio Interface (CPRI), or the like.

Smaller cells using a Time Division Duplex (TDD) system have recently been provided as a measure against a rapidly increasing amount of radio traffic. In the TDD system, the output timings of radio frames at output antenna ends of radio base station devices are made to coincide between the radio base station devices. In addition, in the TDD system, radio frame transmission and reception switching timings are made to coincide between the radio base station devices. The synchronization of reference clocks and reference timings of the radio base station devices is therefore achieved with high precision.

One of methods of synchronizing a reference clock and reference timing with high precision is the Precision Time Protocol (PTP), which is a time synchronization protocol defined in Institute of Electrical and Electronics Engineers (IEEE) 1588. PTP is a protocol for dock synchronization between network-coupled devices.

In a case where time synchronization is achieved between BBUs, for example, a PTP master providing a grandmaster clock (GMC) and each of a plurality of BBUs are coupled to each other in a star topology using a switching hub. As a PTP slave receiving a time from the PTP master, each of the BBUs transmits and receives messages for time synchronization to and from the PTP master, and synchronizes a reference clock and reference timing with the PTP master.

As examples of the related art, Japanese Laid-open Patent Publication No. 2013-106329 and Japanese Laid-open Patent Publication No. 2013-165326 are known.

### SUMMARY

According to an aspect of the embodiments, provided is a communication apparatus for relaying a time synchronizing signal between a master node and a slave node that perform time synchronization using PTP (Precision Time Protocol). The communication apparatus includes: a memory; and a processor coupled to the memory and configured to execute a process including a first process, a second process, a third process, and a fourth process. The first process includes, when the time synchronizing signal relayed by the communication apparatus is a first time synchronizing signal addressed to the slave node, storing a first time, the first time being a time of the communication apparatus at a point in time that the communication apparatus receives the first time synchronizing signal. The second process includes obtaining a second, time, the second time being a time of the master node at a point in time that the first time synchronizing signal is transmitted from the master node to the slave node, from the first time synchronizing signal or a second time synchronizing signal transmitted from the master node to the slave node after the first time synchronizing signal. The third process includes obtaining an amount of offset, the amount of offset being a difference between a reference time of the master node and a reference time of the communication apparatus, using the first time as a time of the slave node in a time synchronizing algorithm of the PTP, and using the second time as the time of the master node. The fourth process includes correcting the reference time of the communication apparatus on a basis of the obtained amount of offset.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a sequence diagram illustrating a flow of transmission and reception of PTP packets (PTP messages) based on IEEE 1588 (PTP);

FIG. 2 is a diagram of assistance in explaining a waiting time correcting method in a relay node;

FIG. 3 illustrates a network topology in a reference example;

FIG. 4 is a sequence diagram illustrating an example of PTP synchronization in a reference example;

FIG. 5 illustrates an example of a network system according to an embodiment;

FIG. 6 is a sequence diagram illustrating an example of operation of the network system illustrated in FIG. 5;

FIG. 7 illustrates an example of coupling of network apparatuses to which a ring protocol is applied;

FIG. 8 is a diagram of assistance in explaining an operation at a time of occurrence of a fault in a ring protocol;

FIG. 9 is a diagram of assistance in explaining an operation at a time of fault recovery in a ring protocol;

FIG. 10 illustrates an example of application of a ring protocol to the network system illustrated in FIG. 5;

FIG. 11 illustrates an example of data structure of a management table and an example of initial setting information;

FIG. 12 illustrates a route of passage of a health check frame in the network system illustrated in FIG. 10;

FIG. 13 illustrates behavior at a time of occurrence of a ring discoupling in an example of the network system (ring network) illustrated in FIG. 10;

FIG. 14 illustrates contents registered (transitions of stored contents) in a management table at a time of occurrence of a fault;

FIG. 15 illustrates a transfer path of a health check message;

FIG. 16 is a diagram of assistance in explaining an operation at a time of ring recovery;

FIG. 17 illustrates contents registered (transitions of stored contents) in a management table at a time of ring recovery;

FIG. 18 is a diagram illustrating an example of configuration of each BBU in an embodiment;

FIG. 19 is a diagram illustrating an example of configuration of a ring/PTP control unit;

FIG. 20 is a diagram illustrating an example of hardware configuration of a BBU;

FIG. 21 is a flowchart illustrating an example of processing in a ring master;

FIG. 22 is a flowchart illustrating an example of processing of changing a route of PTP messages and a PTP slave;

FIG. 23 is a flowchart illustrating an example of processing of changing back PTP routes and PTP slaves;

FIG. 24 is a flowchart illustrating an example of processing in a transit in a ring;

FIG. 25 is a flowchart illustrating an example of operation as a “relay”;

FIG. 26 is a Flowchart illustrating an example of operation as a “slave”;

FIG. 27 is a flowchart illustrating a modification of a first embodiment;

FIG. 28 is a flowchart illustrating a modification of the first embodiment;

FIG. 29 is a diagram illustrating an example of configuration of a second embodiment; and

FIG. 30 is a sequence diagram illustrating an example of operation of the second embodiment.

### DESCRIPTION OF EMBODIMENTS

Each BBU coupled to a PTP master in a star topology may operate on a clock independent of the PTP master, that is, the PTP master and each BBU may operate asynchronously. In this case, for time synchronization (PTP synchronization) based on PTP, the PTP master sequentially transmits and receives PTP messages to and from each BBU as a PTP slave. Therefore, a conventional system is forced to waste a time until PTP synchronization of each BBU is ended.

As one aspect of the present embodiment, provided are solutions for being able to shorten time taken for a plurality of communication apparatuses to synchronize with the reference time of a master.

Embodiments will hereinafter be described with reference to the drawings. The configurations of the embodiments are illustrative, and are not limited to the configurations of the embodiments.

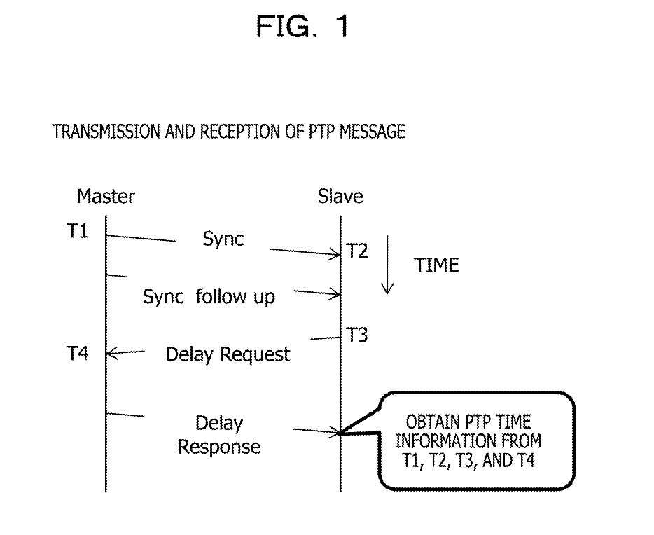

Description will be made of time synchronization (time synchronization algorithm) based on PTP applied in the embodiment. FIG. 1 is a sequence diagram illustrating a flow of transmission and reception of PTP packets (PTP messages) based on IEEE 1588 (PTP). The transmission and reception of PTP messages (message transmission and reception) are performed between a PTP master and a PTP slave.

The PTP master (grandmaster clock (GMC): Master) sends a Sync message to the PTP slave (slave dock (SC): Slave). At this time, the PTP master stores a transmission time T1 of the Sync message. In addition, the PTP master sends a time stamp (Time Stamp: referred to as a time stamp T1) for recording the transmission time T1 by using a Sync Follow Up message, which is sent to the PTP slave following the Sync message.

When the PTP slave receives the Sync message, the PTP slave stores a reception time T2 of the Sync message. In addition, the PTP slave extracts the time stamp T1 from the Sync Follow Up message received following the Sync message, and stores the time stamp T1. Further, the PTP slave transmits a Delay Request message to the PTP master, and stores a transmission time T3 of the Delay Request message as a time stamp 13.

When the PTP master receives the Delay Request message, the PTP master stores a reception time 14 of the Delay Request message. The PTP master transmits a Delay Response message including a time stamp indicating the time T4 (time stamp T4) to the PTP slave.

When the PTP slave receives the Delay Response message, the PTP slave extracts the time stamp T4 from the Delay Response message, and stores the time stamp T4. As a result of the above, the PTP slave can obtain the time stamps T1, T2,13, and T4. Incidentally, the time stamp T1 may be included in the Sync message, and the PTP slave may obtain the time stamp T1 from the Sync message. Incidentally, the Sync message, the Sync Follow Up message, the Delay Request message, and the Delay Response message are PTP messages, and packets including the PTP messages are PTP packets.

The PTP slave obtains a delay time and an offset using the time stamps T1, T2, T3, and T4. Suppose for example that a difference in reference time (offset) between the PTP master and the PTP slave is “X.” Supposing that a transmission delay of the Sync message between the PTP master and the PTP slave is TD12, and that a transmission delay of the Delay Request message between the PTP master and the PTP slave is TD34, the transmission delays are expressed by Equation 1 and Equation 2 in the following;

TD12=(T2−X)−T1 (Equation 1)

TD34=T4−(T3−X) (Equation 2)

Here, assuming that TD12=TD34, Equation 3 is obtained.

(T2−X)−T1=T4−(T3−X) (Equation 3)

The expansion of Equation 3 is “2X=−T1+T2+T3−T4,” which can be rearranged into the following Equation 4 with respect to the offset X.

X={(T2−T1)−(T4−T3)}/2 (Equation 4)

The above principles can also be described as follows. An amount of correction (amount of offset) of the PTP slave time (Time on the slave dock) for synchronization with the PTP master time (Time on the master clock) may be expressed as follows. The amount of correction (amount of offset) refers to the offset X.

Amount of Correction (offsetFromMaster)=<Time on the slave clock>−<Time on the master clock>=(T2−T1)−Average Transmission Line Delay (Equation A)

Here, the average transmission line delay may be expressed as follows,

Average Transmission Line Delay (meanPathDelay)={(T2−T1)+(T4−T3)}/2 (Equation B)

The slave corrects the reference time (reference clock) of the slave such that the offset X becomes zero. The time synchronization between the PTP master and the PTP slave is thereby performed.

Description will next be made of a transparent mode (end-to-end transparent dock (TC)) as one operating systems of relay nodes of PTP applied to the embodiment. A master dock (MC) and a slave dock (SC) are depicted in the sequence illustrated in FIG. 1. On the other hand, in the case of the TC, a relay node is interposed between a node operating as the MC and a node operating as the SC.

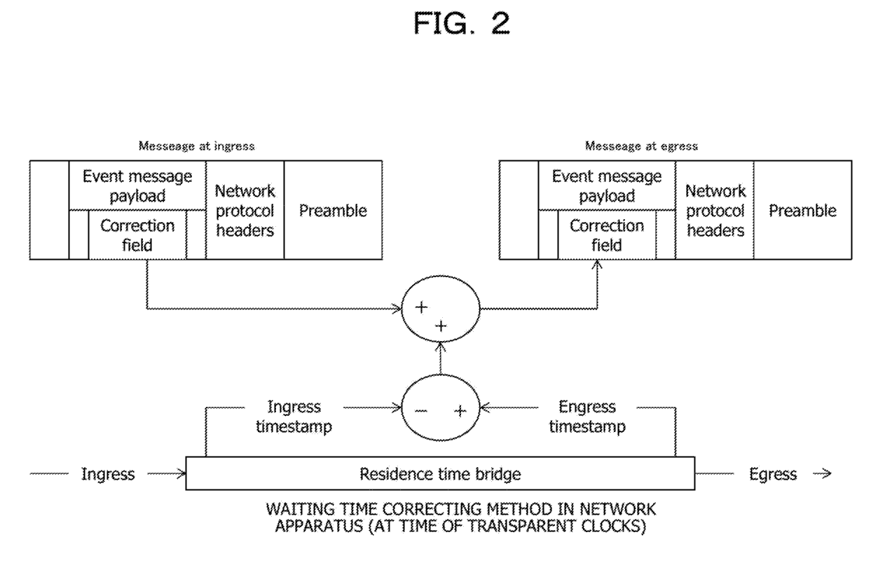

FIG. 2 is a diagram of assistance in explaining a waiting time correcting method in a relay node. In FIG. 2, the relay node (Residence time bridge) has an entry (Ingress) and an exit (Egress). A PTP packet (Message at ingress) received at the entry has a format as follows.

That is, the PTP packet includes a preamble (Preamble), network protocol headers (Network Protocol Headers), an event message (Event Message), and a correction (Correction) field. The Correction field is one of fields included in the PTP message. A residence time at the relay node is recorded in the Correction field.

In FIG. 2, the relay node obtains the residence time at the relay node by subtracting a time of reception of the PTP packet at the entry from a time of transmission of the PTP packet from the exit. The obtained residence time is added to the residence time recorded in the Correction field in the PTP packet received at the entry. That is, the Correction field is updated. The PTP packet (Message at egress) whose Correction field is updated is transmitted from the exit.

In a case where there are a plurality of relay nodes (TCs) between the MC and the SC, a residence time at each TC is added to the Correction field. Hence, the value of the Correction field arriving at the destination (SC) of the PTP message indicates a sum total of the residence times of the TCs. The SC can calculate an accurate delay time between the SC and the MC by using the value of the Correction field (sum total of the residence times of the TCs). An average transmission line delay in the case of the TCs is obtained by the following Equation 5, for example. The value of the Correction field in Equation 5 indicates a sum of a sum total of residence times in a direction from the master to the slave and a sum total of residence times in a direction from the slave to the master.

Average Transmission Line Delay={(T4−T1)−(T3−T2)}−Value of Correction Field/2 (Equation 5)

In addition, for example, an amount of correction (offset) can be calculated as follows using the transmission line delay and the value of the Correction field (residence times for the Sync message).

Amount of Correction=T2−T1−Average Transmission Line Delay−Value of Correction Field (Equation 6)

Incidentally, unlike Equation 5, the “Value of Correction Field” in Equation 6 is residence times in an outward path or a returning path. For example, the “Value of Correction Field” in Equation 6 is the value of the Correction field in the Sync message received by the SC.

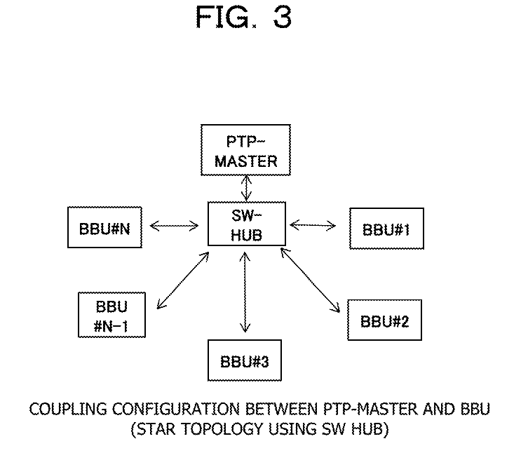

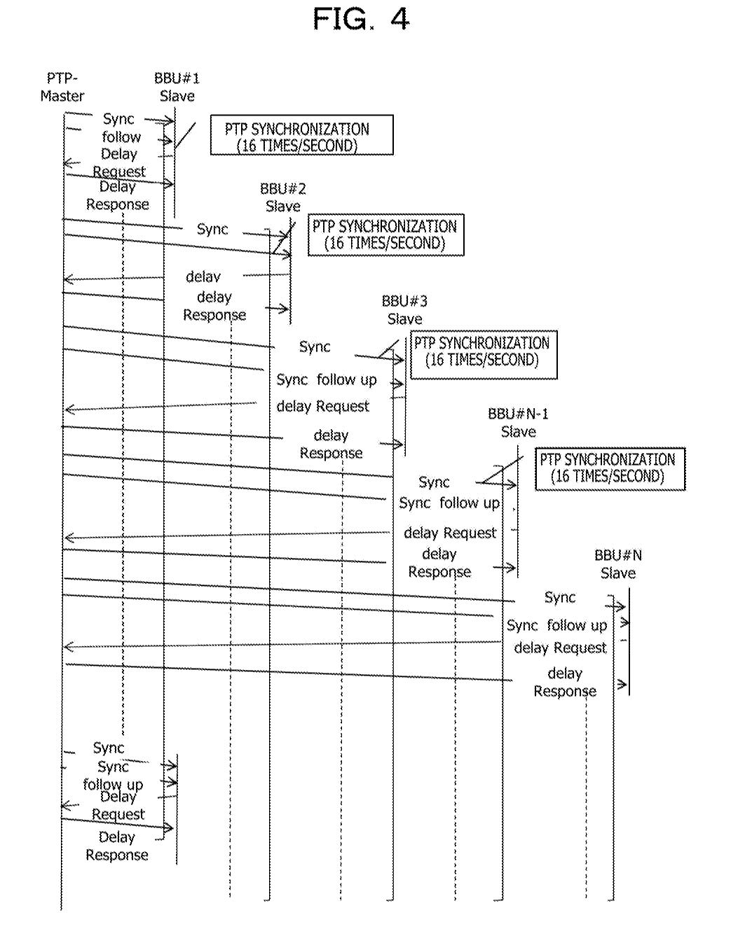

FIG. 3 illustrates a network topology in a reference example. FIG. 4 is a sequence diagram illustrating an example of PTP synchronization in a reference example. As illustrated in FIG. 3, a PTP master (PTP-MASTER) as a master clock is coupled in a star topology to a plurality of BBUs (BBUs #1, #2, . . . , #N-1, #N (N is a positive integer)) via a switching hub (SW hub).

Because each BBU is coupled to the FTP master in a star topology, the PTP master and each BBU (slave) operate on clocks independent of each other, that is, operate asynchronously. Therefore, as illustrated in FIG. 4, the PTP master sequentially performs FTP synchronization with each BBU by exchanging (transmitting and receiving) the FTP messages illustrated in FIG. 1 with each BBU. Therefore, the system of the reference example illustrated in FIG. 3 and FIG. 4 wastes a time until completion of all of the PTP synchronization sequentially performed between the PTP master and each BBU. In the embodiments, description will be made of a time synchronization system, a communication apparatus, a radio base station device (hereinafter referred to also as a “base station”) that can shorten time taken to achieve high-precision time synchronization of a plurality of devices. PTP synchronization will be illustrated as high-precision time synchronization in the embodiments.

In addition, in the reference example, because the PTP master and each BBU (slave) operate asynchronously, time synchronization (PTP synchronization) is performed 16 times per second, for example, between the PTP master and each BBU (slave). Such frequent message transmissions and receptions for PTP synchronization impose a heavy load on the network. In the embodiments, description will be made of a time synchronization system, a communication apparatus, and a base station that can reduce a load on a network when high-precision time synchronization of a plurality of devices is achieved.

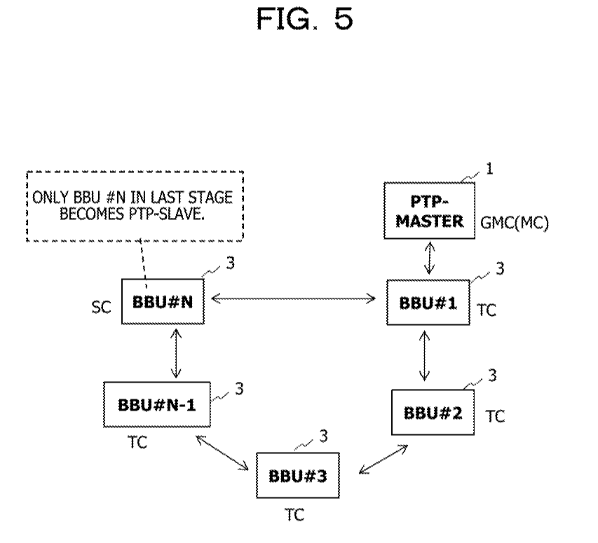

FIG. 5 illustrates an example of a network system (time synchronization system) according to a first embodiment. In FIG. 5, the network system is a system for performing a time synchronization method. The network system includes a node as a PTP master (GMC) 1 and a plurality of BBUs (136Us #1, #2, . . . , #N-1, #N (N is a positive integer)) 3. However, the network system illustrated in FIG. 5 is coupled in a ring topology rather than a star topology as illustrated in the reference example (FIG. 3).

In the example of FIG. 5, the plurality of BBUs 3 (BBUs #1, #2, . . . , #N-1, #N) are coupled in series with each other in order of numbers thereof. The BBU 3 located in a last stage (BBU #N) operates as a PTP slave (SC), and performs PTP synchronization in a transparent mode. On the other hand, the BBU #1, the BBU #2, . . . , the BBU #N-1 located between the PTP master and the BBU #N operate as relay nodes (transparent clocks (TCs)).

Then, PTP synchronization is performed between the PTP master and the BBU #N as the PTP slave. At the time of the PTP synchronization, each of the BBUs operating as the relay nodes intercepts PTP time information, and establishes synchronization with the PTP master. This can shorten time taken for each BBU 3 to perform time synchronization with the PTP master 1. In addition, amounts of message transmission and reception are reduced, so that a network load can be reduced. In addition, a load on the PTP master is also reduced.

The PTP master 1 is an example of a “master node” or a “master device.” Each of the BBUs #1 to #N-1 is an example of a “relay node,” a “communication apparatus,” or a “relay device.” The BBU #N is an example of a “slave node” or a “slave device.”

As described with reference to FIG. 2, in the transparent mode, residence times (occurring due to waits for processing) of the Sync message and the Delay Request message at BBUs (relay nodes), which residence times are a major cause of a transmission delay error, are measured. A relay node adds a result of measurement of the residence time to the Correction field of a PTP packet, and transmits the result of measurement of the residence time to a subsequent stage. This enables calculation of a more accurate delay time.

The residence time of the Sync message may be added to the Correction field of the Sync message. In addition, the residence time of the Sync message may be set in the Correction field of the Sync Follow up message. In addition, the residence time of the Delay Request message may be set in the Correction field of the Delay Response message. The BBUs (relay BBUs) operating as all of the relay nodes on the transfer path of the PTP packet calculate a residence time and add the residence time to the Correction fields. Hence, the Correction fields of the Sync message and the Delay Response message received by the PTP slave include a sum total of the residence times at the relay BBUs.

The PTP slave uses the sum total of the residence times to calculate time synchronization (offset). On the other hand, each relay BBU refers to the values of the Correction fields by intercepting the PTP packets. However, the residence times indicated in the Correction fields include residence times unnecessary (surplus) in establishment of synchronization of the relay BBUs. Therefore, each relay BBU recalculates a residence time.

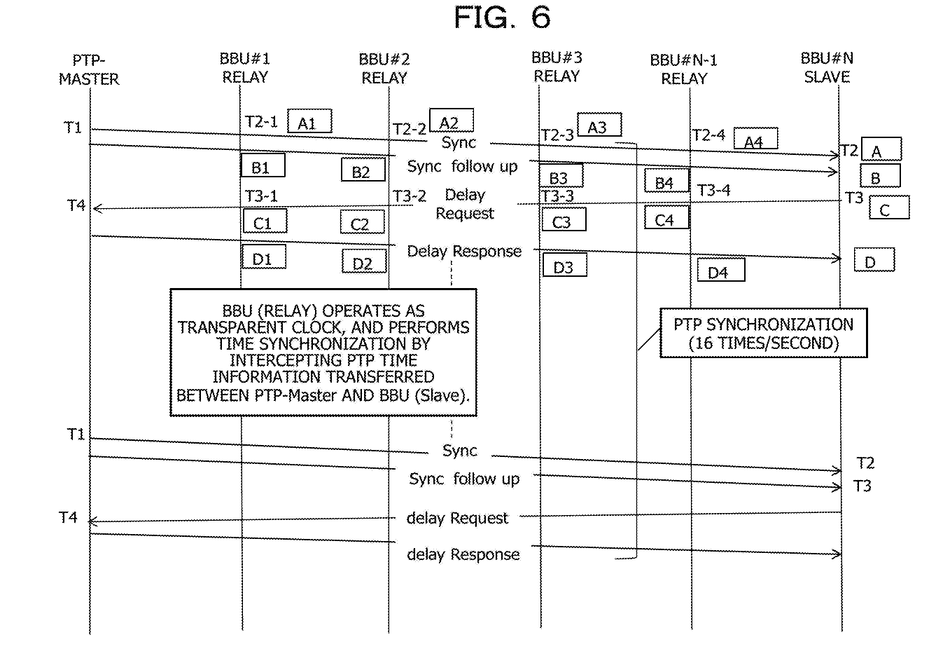

FIG. 6 is a sequence diagram illustrating an example of operation of the network system illustrated in FIG. 5. In FIG. 6, the PTP master (PTP-Master) transmits a Sync message to the BBU #N as the PTP slave, and stores the transmission time of the Sync message as a time stamp “T1.”

The BBU #1 as a relay node performs the following processing at a time of reception of the Sync message (A1 in FIG. 6). The BBU #1 stores the time of the BBU #1 at the time point of the reception of the Sync message as “T2-1.” “T2-1” is an example of a “first time,” and the processing of storing “T2-1” is an example of “first processing.” In addition, the BBU #1 extracts the value of a Correction field of the Sync message, and stores the value of the Correction field as a residence time “ta-1.” The processing of storing the value of the Correction field as the residence time “ta-1” is an example of “seventh processing.” Further, the BBU #1 adds a residence time “Δta2” at the BBU #1. to the Correction field of the Sync message, and transfers the Sync message in which the Correction field is updated to the node in the next stage (BBU #2).

The BBU #2 as a relay node performs the following processing at a time of reception of the Sync message (A2 in FIG. 6). The BBU #2 stores the reception time of the Sync message as “T2-2.” “T2-2” is an example of the “first time,” and the processing of storing “T2-2” is an example of the “first processing.” In addition, the BBU #2 extracts the value of the Correction field of the Sync message, and stores the value of the Correction field as a residence time “ta-2.” The processing of storing the residence time “ta-2” is an example of the “seventh processing.” Further, the BBU #2 adds a residence time “Δta2” at the BBU #2 to the Correction field of the Sync message, and transfers the Sync message in which the Correction field is updated to the node in the next stage (BBU #3).

The BBU #3 as a relay node performs the following processing at a time of reception of the Sync message (A3 in FIG. 6). The BBU #3 stores the reception time of the Sync message as “T2-3.” “T2-3” is an example of the “first time,” and the processing of storing “T2-3” is an example of the “first processing.” In addition, the BBU #3 extracts the value of the Correction field of the Sync message, and stores the value of the Correction field as a residence time “ta-3.” The processing of storing the residence time “ta-3” is an example of the “seventh processing.” Further, the BBU #3 adds a residence time “Δta3” at the BBU #3 to the Correction field of the Sync message, and transfers the Sync message in which the Correction field is updated to the node in the next stage (BBU #N-1).

The BBU #N-1 as a relay node performs the following processing at a time of reception of the Sync message (A4 in FIG. 6). The BBU #N-1 stores the reception time of the Sync message as “T2-4.” “T2-4” is an example of the “first time,” and the processing of storing “T2-4” is an example of the “first processing.” In addition, the BBU #N-1 extracts the value of the Correction field of the Sync message, and stores the value of the Correction field as a residence time “ta-4.” The processing of storing the residence time “ta-4” is an example of the “seventh processing.” Further, the BBU #N-1 adds a residence time “Δta4” at the BBU #N-1 to the Correction field of the Sync message, and transfers the Sync message in which the Correction field is updated to the node in the next stage (BBU #N).

The BBU #N as the PTP slave (last stage) performs the following processing at a time of reception of the Sync message (A in FIG. 6). The BBU #N stores the reception time of the Sync message as a time stamp “T2,” and extracts the value of the Correction field of the Sync message and stores the value of the Correction field as a residence time “ta.”

Following the Sync message, the PTP master generates a Sync follow up message including the time stamp “T1” indicating the transmission time of the Sync message, and transmits the Sync follow up message to the BBU #N as the PTP slave. The time stamp “T1” is an example of a “second time.”

The BBU #1 performs the following processing at a time of reception of the Sync follow up message (B1 in FIG. 6). The BBU #1 stores the time stamp T1 included in the Sync follow up message. The processing of storing the time stamp T1 is an example of “second processing,” In addition, the BBU #1 transfers the Sync follow up message to the node in the next stage (BBU #2).

The BBU #2 performs the following processing at a time of reception of the Sync follow up message (B2 in FIG. 6). The BBU #2 stores the time stamp T1 included in the Sync follow up message. The processing of storing the time stamp T1 is an example of the “second processing.” The BBU #2 transfers the Sync follow up message to the node in the next stage (BBU #3).

The BBU #3 performs the following processing at a time of reception of the Sync follow up message (83 in FIG. 6). The BBU #3 stores the time stamp T1 included in the Sync follow up message. The processing of storing the time stamp T1 is an example of the “second processing.” The BBU #3 transfers the Sync follow up message to the node in the next stage (BBU #N-1).

The BBU #N-1 performs the following processing at a time of reception of the Sync follow up message (B4 in FIG. 6). The BBU #N-1 stores the time stamp T1 included in the Sync follow up message. The processing of storing the time stamp T1 is an example of the “second processing.” The BBU #3 transfers the Sync follow up message to the node in the next stage (BBU #N).

The BBU #N performs the following processing at a time of reception of the Sync follow up message (B in FIG. 6). The BBU #N stores the time stamp T1 included in the Sync follow up message.

The BBU #N further performs the following processing (C in FIG. 6). The BBU #N generates a Delay Request message and transmits the Delay Request message to the PTP master, and stores the transmission time of the Delay Request message as a time stamp “T3.”

The BBU #N-1 performs the following processing at a time of reception of the Delay Request message (C4 in FIG. 6). The BBU #N-1 adds a residence time “Δtc4” at the BBU #N-1 to the Correction field of the Delay Request message, and transfers the Delay Request message in which the Correction field is updated to the node in the next stage (BBU #3). In addition, the BBU #N-1 stores the transmission time of the Delay Request message as “T3-4.” The time “T3-4” is an example of a “third time.” The processing of storing “T3-4” is an example of “fifth processing.” Further, the BBU #N-1 stores the value set in the Correction field as a residence time “tc-4.” The value set in the Correction field is the Correction field value after the addition of Δtc4. The residence time “tc-4” is an example of a “first period.” The processing of storing the residence time “tc-4” is an example of “eighth processing.”

The BBU #3 performs the following processing at a time of reception of the Delay Request message (C3 in FIG. 6). The BBU #3 adds a residence time “Δtc3” at the BBU #3 to the Correction field of the Delay Request message, and transfers the Delay Request message in which the Correction field is updated to the node in the next stage (BBU #2). In addition, the BBU #3 stores the transmission time of the Delay Request message as “T3-3.” The time “T3-3” is an example of the “third time.” The processing of storing “T3-3” is an example of the “fifth processing.” Further, the BBU #3 stores the value set in the Correction field as a residence time “tc-3.” The value set in the Correction field is the Correction field value after the addition of Δtc3, and is a cumulative value of Δtc4 and Δtc3, for example. The residence time “tc-3” is an example of the “first period.” The processing of storing the residence time “tc-3” is an example of the “eighth processing.”

The BBU #2 performs the following processing at a time of reception of the Delay Request message (C2 in FIG. 6). The BBU #2 adds a residence time “Δtc2” at the BBU #2 to the Correction field of the Delay Request message, and transfers the Delay Request message in which the Correction field is updated to the node in the next stage (BBU #1). In addition, the BBU #2 stores the transmission time of the Delay Request message as “T3-2.” The time “T3-2” is an example of the “third time.” The processing of storing “T3-2” is an example of the “fifth processing.” Further, the BBU #2 stores the value set in the Correction field as a residence time “tc-2.” The value set in the Correction field is the Correction field value after the addition of Δtc2, and is a cumulative value of Δtc4, Δtc3, and Δtc2, for example. The residence time “tc-2” is an example of the “first period.” The processing of storing the residence time “tc-2” is an example of the “eighth processing.”

The BBU #1 performs the following processing at a time of reception of the Delay Request message (C1 in FIG. 6). The BBU #1 adds a residence time “Δtc1” at the BBU #1 to the Correction field of the Delay Request message, and transfers the Delay Request message in which the Correction field is updated to the node in the next stage (PTP master). In addition, the BBU #1 stores the transmission time of the Delay Request message as “T3-1.” The time “T3-1” is an example of the “third time.” The processing of storing “T3-1” is an example of the “fifth processing.” Further, the BBU #1 stores the value set in the Correction field as a residence time “tc-1.” The value set in the Correction field is the Correction field value after the addition of Δtc1, and is a cumulative value of Δtc4, Δtc3, Δtc2, and Δtc1, for example. The residence time “td-1” is an example of the “first period.” The processing of storing the residence time “tc-1” is an example of the “eighth processing.”

The PTP master performs the following processing at a time of reception of the Delay Request message. The PTP master stores the reception time of the Delay Request message as a time stamp “T4.” The time stamp T4 is an example of a “fourth time.” In addition, the PTP master generates a Delay Response message including the time stamp “T4,” and transmits the Delay Response message to the BBU #N as the PTP slave. The value of the Correction field (sum of the residence times at the respective relay nodes) of the Delay Request message is set in the Correction field of the Delay Response message.

The BBU #1 performs the following processing at a time of reception of the Delay Response message (D1 in FIG. 6). The BBU #1 obtains and stores the time stamp T4 included in the Delay Response message. The processing of obtaining the time stamp 14 is an example of “sixth processing.” In addition, the BBU #1 extracts a value from the Correction field of the Delay Response message. The value includes the residence times of the Delay Request message at the respective relay nodes (the BBU #1, the BBU #2, the BBU #3, and the BBU #N-1) which residence times are added at the respective relay nodes. The residence times are times unnecessary for offset calculation at the BBU #1. Therefore, the BBU #1 subtracts the residence time tc-1 (an example of the “first period”) stored in C1 from the value extracted from the Correction field (an example of a “second period”), and stores a result of the subtraction as a residence time “td-1.” Incidentally, the value of the residence time td-1 is zero. The residence time “td-1” is an example of a “second residence time.” The processing of obtaining and storing the residence time “td-1” is an example of “ninth processing.”

The BBU #1 can calculate an offset using the time stamps T1, T2-1, T3-1, and T4 and the residence times ta-1 and td-1, and synchronize a time at the BBU #1 with the time of the PTP master. For example, the offset may be obtained on the basis of Equation 4 using the time stamps T1, T2-1, T3-1, and T4. Alternatively, the offset may be obtained on the basis of Equation 5 and Equation 6 using the time stamps T1, T2-1, T3-1, and T4 and the residence times ta-1 and td-1.

For example, when obtaining the offset on the basis of Equation 4, the BBU #1 obtains the offset X by performing the calculation of the following Equation 4.1. In the following equations, hyphens used in the notation of time stamps and residence times will be represented by underscores. For example, “T2-1” will be expressed as “T2_1.”

X={(“T2_1”−“T1”)−(“T4”−“T3_1”)}/2 (Equation 4.1)

In addition, when the precision of the offset is to be increased in consideration of the residence times at the relay communication apparatuses, the offset X (amount of correction) is calculated by the following Equation 6.1 using the time stamps “T1” and “T2-1 (T2_1)” and the residence time “ta-1 (ta_1).”

X=“T2_1”−“T1”−“Average Transmission Line Delay”−“ta_1 (Value of Correction Field)” (Equation 6.1)

The “average transmission line delay” may be obtained by the following Equation 5.1 using the time stamps “T4,” “T1,” “T3_1,” and “T2_1” and the residence times “ta_1” and “td_1” at the BBU #1, for example. The residence time “ta_1.” is an example of a “first residence time.” The residence time “td_1” is an example of a “second residence time.”

Average Transmission Line Delay={(“T4”−“T1”)−(“T3_1”−“T2_1”)}−(“ta_1”−“td_1”)/2 (Equation 5.1)

(“ta_1”+“td_1”) in the above-described Equation 5.1 represents a sum total of residence times at the BBU #1 (TC) (value of the Correction field). Thus obtaining the amount of offset on the basis of Equation 5.1 and Equation 6.1 is an example of “considering the first residence time and the second residence time when obtaining the amount of offset in the third processing.”

Incidentally, the value of the average transmission line delay or the parameters for obtaining the average transmission line delay may be obtained by the relay communication apparatuses (BBUs #1 to #N-1) as illustrated in the above-described operation example, or may be obtained from another communication apparatus by communication. When the average transmission line delay or the parameters are obtained from another communication apparatus, the processing in which the relay communication apparatuses obtain the time stamps for obtaining the delay in the transmission line from the slave to the master, that is, the processing of obtaining the times “T3-x” and “T4-x” (x is a positive integer) can be omitted. In addition, each relay communication apparatus may use a one-way transmission line delay (delay time) in place of the average transmission line delay.

After obtaining the amount of correction (offset X), the BBU #1 corrects the reference time of the BBU #1 such that the offset X becomes zero. A difference between the reference time of the BBU #1 and the reference time of the PTP master consequently becomes zero.

The BBU #2 performs the following processing at a time of reception of the Delay Response message (D2 in FIG. 6). The BBU #2 obtains and stores the time stamp T4 included in the Delay Response message. The processing of obtaining the time stamp T4 is an example of the “sixth processing.” In addition, the BBU #2 extracts the value from the Correction field of the Delay Response message. The value includes the residence times added at the BBU #2, the BBU #3, and the BBU #N-1, which residence times are unnecessary. Therefore, the BBU #2 subtracts the residence time tc-2 (an example of the “first period”) stored in C2 from the value extracted from the Correction field (an example of the “second period”), and stores a result of the subtraction as a residence time “td-2.” The residence time “td-2” is for example the residence time “Δtc1” at the BBU #1, which is the node in the previous stage that transferred the Delay Request message. The residence time “td-2” is an example of the “second residence time.” The processing of obtaining and storing the residence time “td-2” is an example of the “ninth processing.”

The BBU #2 can calculate an offset using the time stamps T1, T2-2, T3-2, and T4 and the residence times ta-2 and td-2, and synchronize with the time of the PTP master by correcting a time at the BBU #2.

For example, when obtaining the offset on the basis of Equation 4, the BBU #2 obtains the offset X by performing the calculation of the following Equation 4.2.

X={(“T2_2”−“T1”)−(“T4”−“T3_2”)}/2 (Equation 4.2)

In addition, in the case where the offset is obtained on the basis of Equation 6, the offset X (amount of correction) is calculated using the time stamps “T1” and “T2-2 (T2_2)” and the residence time “ta-2 (ta_2).”

X=“T2_2”−“1”−“Average Transmission Line Delay”−“ta_2 (Value of Correction Field)” (Equation 6.2)

The “average transmission line delay” may be obtained using the following Equation 5.2 at the BBU #2, for example.

Average Transmission Line Delay={(“T4”−“T1”)−(“T3_2”−“T2_2”)}−(“ta_2”+“td2”)/2 (Equation 5.2)

(“ta_2”+“td_2”) in the above-described Equation 5.2 represents a sum total of residence times (value of the Correction field) at the BBU #2 (TC). The calculation of the amount of offset using Equation 5.2 and Equation 6.2 is an example of “considering the first residence time and the second residence time when obtaining the amount of offset in the third processing.”

The BBU #3 performs the following processing at a time of reception of the Delay Response message (D3 in FIG. 6). The BBU #3 obtains and stores the time stamp T4 included in the Delay Response message. The processing of obtaining the time stamp T4 is an example of the “sixth processing.” In addition, the BBU #3 extracts the value from the Correction field of the Delay Response messages. The value includes the residence times added at the BBU #3 and the BBU #N-1, which residence times are unnecessary. Therefore, the BBU #3 subtracts the residence time tc-3 (an example of the “first period”) stored in C3 from the value extracted from the Correction field (an example of the “second period”), and stores a result of the subtraction as a residence time “td-3.” The residence time “td-3” is for example a cumulative value of the residence time “Δtc1” at the BBU #1 and the residence time “Δtc2” at the BBU #2, the BBU #1 and the BBU #2 being the nodes in the previous stages that transferred the Delay Request message. The residence time “td-3” is an example of the “second residence time.” The processing of obtaining and storing the residence time “td-3” is an example of the “ninth processing.”

The BBU #3 can calculate an offset using the time stamps T1, T2-3, T3-3, and T4 and the residence times ta-3 and td-3, and synchronize with the time of the PTP master by correcting a time at the BBU #3.

For example, when obtaining the offset on the basis of Equation 4, the BBU #3 obtains the offset X by performing the calculation of the following Equation 4.3.

X={(“T2_3”−“T1”)−(“T4”−“T3_3”)}/2 (Equation 4.3)

In addition, in the case where the offset is obtained on the basis of Equation 6, the offset X (amount of correction) is calculated using the following Equation 6.3.

X=“T2_3”−“T1”−“Average Transmission Line Delay”−“ta_3 (Value of Correction Field)” (Equation 6.3)

The “average transmission line delay” may be obtained using the following Equation 5.3 at the BBU #3, for example.

Average Transmission Line Delay={(“T4”−“T1”)−(“T3_3”−“T2_3”)}−(“ta_3”+“td_3”)/2 (Equation 5.3)

(“ta_3”+“td_3”) in the above-described Equation 5.3 represents a sum total of residence times (value of the Correction field) at the BBU #3 (TC). The calculation of the amount of offset using Equation 5.3 and Equation 6.3 is an example of “considering the first residence time and the second residence time when obtaining the amount of offset in the third processing.”

The BBU #N-1 performs the following processing at a time of reception of the Delay Response message (D4 in FIG. 6). The BBU #N-1 obtains and stores the time stamp T4 included in the Delay Response message. The processing of obtaining the time stamp T4 is an example of the “sixth processing.” In addition, the BBU #N-1 extracts the value from the Correction field of the Delay Response message. The value includes the residence time added at the BBU #N-1, which residence time is unnecessary. Therefore, the BBU #N-1 subtracts the residence time tc-4 (an example of the “first period”) stored in C4 from the value extracted from the Correction field (an example of the “second period”), and stores a result of the subtraction as a residence time “td-4.” The residence time “td-4” is for example a cumulative value of the residence time “Δtc1” at the BBU #1, the residence time “Δtc2” at the BBU #2, and the residence time “Δtc3” at the BBU #3, the BBU #1, the BBU #2, and the BBU #3 being the nodes in the previous stages that transferred the Delay Request message. The residence time “td-4” is an example of the “second residence time.” The processing of obtaining and storing the residence time “td-4” is an example of the “ninth processing.”

The BBU #N-1 can calculate an offset using the time stamps T1, T2-4, T3-4, and T4 and the residence times ta-4 and td-4, and synchronize with the time of the PTP master by correcting a time at the BBU #N-1.

For example, when obtaining the offset on the basis of Equation 4, the BBU #N-1 obtains the offset X by performing the calculation of the following Equation 4.4.

X={(“T2_4”−“T1”)−(“T4”−“T3_4”)}/2 (Equation 4.4)

In addition, in the case where the offset is obtained on the basis of Equation 6, the offset X (amount of correction) is calculated using the following Equation 6.4.

X=“T2_4”−“T1”−“Average Transmission Line Delay”−“ta_4 (Value of Correction Field)” (Equation 6.4)

The “average transmission line delay” may be obtained using the following Equation 5.4 at the BBU #N-1, for example.

Average Transmission Line Delay={(“T4”−“T1”)−(“T3_4”−“T2_4”)}−(“ta_4”+“td_4”)/2 (Equation 5.4)

(“ta_4”+“td_4”) in the above-described Equation 5.4 represents a sum total of residence times (value of the Correction field) at the BBU #N-1 (TC). The calculation of the amount of offset using Equation 5.4 and Equation 6.4 is an example of “considering the first residence time and the second residence time when obtaining the amount of offset in the third processing.”

The BBU #N (slave) performs the following processing at a time of reception of the Delay Response message (D in FIG. 6). The BBU #N stores the time stamp T4 included in the Delay Response message. In addition, the BBU #N extracts the value from the Correction field of the Delay Response message, and stores the value as a residence time “td.”

The BBU #N can calculate an offset using the time stamps T1, T2, T3, and T4 and the residence times ta and td, and synchronize with the time of the PTP master by correcting a time at the BBU #N. The operation described above is performed a given number of times in one second (for example 16 times in one second).

In the above description, the PTP messages (PTP packets) are an example of “time synchronizing signals.” The Sync message is an example of a “first time synchronizing signal.” The Sync follow up message is an example of a “second time synchronizing signal.” The Delay Request message is an example of a “third time synchronizing signal.” The Delay Response message is an example of a “fourth time synchronizing signal.” The offset calculation is an example of “calculation for synchronizing the reference time of the communication apparatus with the reference time of the master node” or “calculation processing.”

In addition, the Correction field is an example of a “region in which a residence time at each communication apparatus relaying each of the first to fourth time synchronizing signals is added.” In addition, ta-x, tc-x, and td-x (x is an integer of one or more) are an example of “residence times.” ta-x is an example of a “first residence time.” tc-x is an example of a “first period.” The value stored in the Correction field at the time of reception of the Delay Response message is an example of a “second period.” td-x is an example of a “second residence time.”

According to the operation example described above, while PTP synchronization processing is performed between the PTP master and the PTP slave (BBU #N), the BBU #1, the BBU #2, the BBU #3, and the BBU #N-1 as the relay nodes also perform PTP synchronization using the PTP messages. Hence, as compared with the reference example, a load on the network can be reduced because it is possible to omit the transmission and reception of PTP messages for individual PTP synchronization processing between the PTP master and each BBU. In addition, a load on the PTP master can also be reduced.

Incidentally, in the operation example described with reference to FIG. 6, each of the relay nodes may obtain the offset on the basis of Equation 4 using only the time stamps among the time stamps and the residence times obtained in the foregoing, and correct the reference dock and the reference timing. That is, the residence times may not be used for the offset calculation.

In addition, as described above, there is a method of calculating the amount of offset on the basis of Equation 5 and Equation 6 using the residence times as a higher precision method of obtaining the amount of offset than the method of calculating the amount of offset on the basis of Equation 4. In this case, as already described, as for the “value of the Correction field (sum total of residence times of the TC)” in Equation 5, the relay devices use a value obtained by adding together the residence times “ta-x” and “td-x,” and the slave device uses a value obtained by adding together the residence times ta and td. In addition, as for the “value of the Correction field (residence time for the Sync message)” in Equation 6, the relay devices use “ta-x,” and the slave device uses “ta.”

The plurality of BBUs 3 of the network illustrated in FIG. 5 have a ring topology. In this case, when a fault occurs in a BBU 3 operating as a relay node or a link relaying the PTP messages, a problem can occur in that it is difficult to establish PTP synchronization between the PTP master and the PTP slave. Description will next be made of a ring protocol applied in the first embodiment.

On a ring network formed in a ring topology, a flow of data ceases when a fault occurs in even one of nodes (network apparatuses or data transfer devices) forming the ring and links (transmission lines) connecting nodes to each other. Therefore, network fault detection and path switching are performed.

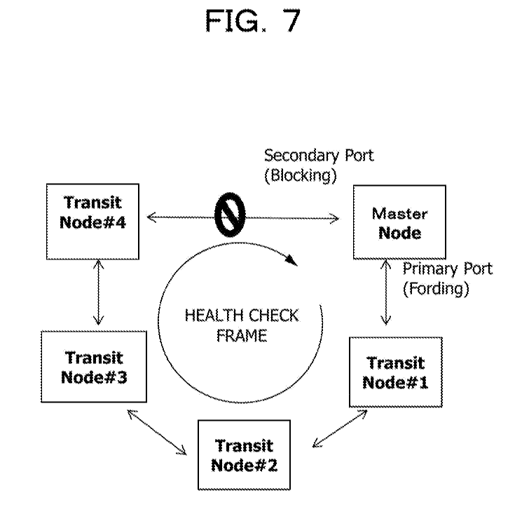

FIG. 7 illustrates an example of coupling of network apparatuses to which a ring protocol is applied. In FIG. 7, a plurality of nodes (network apparatuses or data transfer devices) are coupled to each other in a ring form, and one of the plurality of nodes is set as a master node (Master Node). The other nodes are set as transit nodes (Transit Nodes). In the example of FIG. 7, transit nodes #1 to #4 are illustrated. That is, FIG. 7 illustrates an example with the number of nodes N=5.

One of ports of the master node which ports belong to the ring is set as a primary port (Primary Port), and another port is set as a secondary port (Secondary Port). The primary port is coupled to the transit node #1. The secondary port is coupled to the transit node #4.

The master node is a node monitoring whether the ring is in a normal state. The master node transmits a health check frame from the primary port (Primary Port). The health check frame is transferred from the transit node #1 through the transit node #2, the transit node #3, and the transit node #4 to the master node in this order.

The master node determines the normality of the network on the basis of whether or not the health check frame transmitted from the primary port goes around the ring and returns from the secondary port. When the health check frame returns, the master node determines that the network is normal. When the health check frame does not return, the master node determines that a fault has occurred in the network.

The transit nodes (Transit Nodes) #1 to #4 are nodes that transfer the health check frame from the master node as it is, and which transmit a control frame to the master node when detecting a fault. In the example of FIG. 7, the transit nodes #1 to #4 are illustrated.

In the example of FIG. 7, the primary port of the master node is set in a forwarding (Forwarding) state capable of transmitting and receiving all line data. On the other hand, the secondary port is set in a blocking (Blocking) state in which the secondary port receives the health check frame and control frames notifying the location of a fault, and blocks frames (for example data frames) other than the health check frame and the control frames. The blocking state avoids a possibility that when a loop occurs, transferred frames infinitely circulate and squeeze a band, causing a state in which communication is stopped.

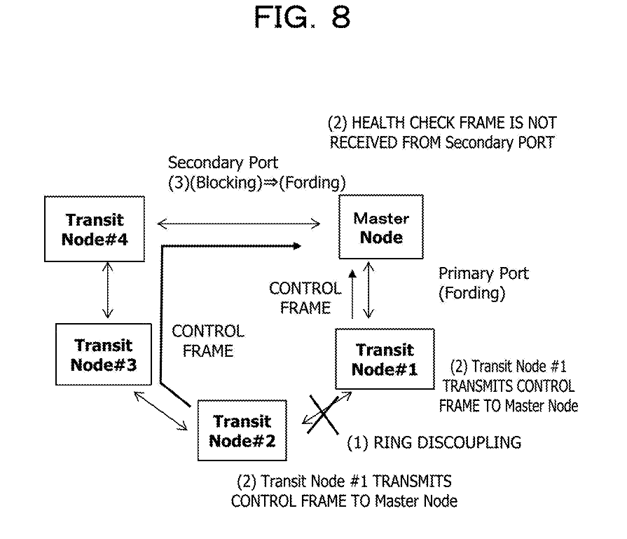

FIG. 8 is a diagram of assistance in explaining an operation at a time of occurrence of a fault in a ring protocol. In an example illustrated in FIG. 8, a fault has occurred in a link between the transit node #1 and the transit node #2 (FIG. 8(1)). The link fault is detected by each of the transit node #1 and the transit node #2.

Detecting the fault, the transit node #1 and the transit node #2 transmit a control frame to the master node to notify the master node that the fault has occurred (FIG. 8(2)).

The master node can detect the fault in the ring by ceasing to receive the health check frame from the secondary port. The master node identifies the location of the fault by using information included in the control frames, and changes a route so as to avoid the fault location.

In the example of FIG. 8, the master node can obtain information indicating the fault location from at least one of the control frame from the transit node #1 which control frame arrives at the primary port and the control frame from the transit node #2 which control frame arrives at the secondary port. The master node can identify the fault location on the basis of the information.

The master node changes the state of the secondary port from the blocking state to the forwarding state. Then, the master node changes a frame route so as to avoid the fault location. In the example of FIG. 8, the frame route is changed to a first route and a second route.

In the first route, a frame is transmitted from the primary port to the transit node #1. In the second route, on the other hand, a frame is transmitted from the secondary port, passes through the transit node #4 and the transit node #3, and then arrives at the transit node #2.

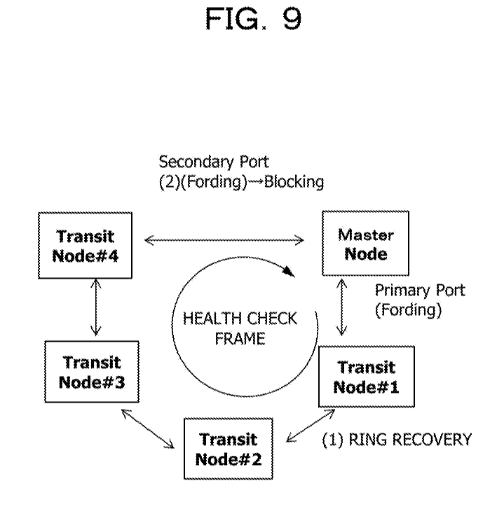

FIG. 9 is a diagram of assistance in explaining an operation at a time of fault recovery in a ring protocol. The master node continues transmitting the health check frame also after detecting the fault. The master node determines that the fault is continuing unless the health check frame arrives at the secondary port.

When the link is restored and the ring becomes normal, the health check frame arrives at the secondary port. The master node recognizes the recovery from the fault on the basis of the arrival of the health check frame at the secondary port. Then, the master node changes the secondary port from the forwarding state to the blocking state, and returns the frame communication routes to the original form illustrated in FIG. 7.

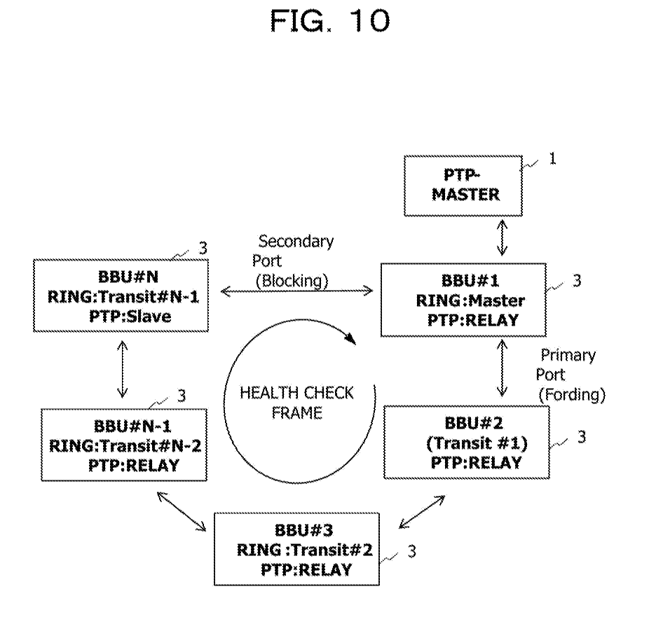

The above-described ring protocol is applied to the network system illustrated in FIG. 5. FIG. 10 illustrates an example of application of a ring protocol to the network system illustrated in FIG. 5. In FIG. 10, the BBU #1 operates as the master node in the ring illustrated in FIG. 7 (which master node will be referred to also as a “ring master”). On the other hand, the BBU #2, the BBU #3, the BBU #N-1, and the BBU #N operate as transit nodes (also referred to simply as “transits”) #1 to #N-1.

The BBU #1 is an example of a “relay node.” The BBUs #2 to #N are an example of a “plurality of nodes forming the ring together with the relay node.” The BBU #N is an example of a “first node as the slave node among the plurality of nodes, the first node being adjacent to the relay node in the ring.”

Communication route switching operation based on the ring protocol is performed as follows. One BBU to be operated as the ring master is determined according to an initial setting. The ring master centrally controls the other BBUs forming the ring network using a ring/PTP management table (hereinafter simply denoted as a “management table”), and performs PTP message route (path) switching operation at a time of occurrence of a fault.

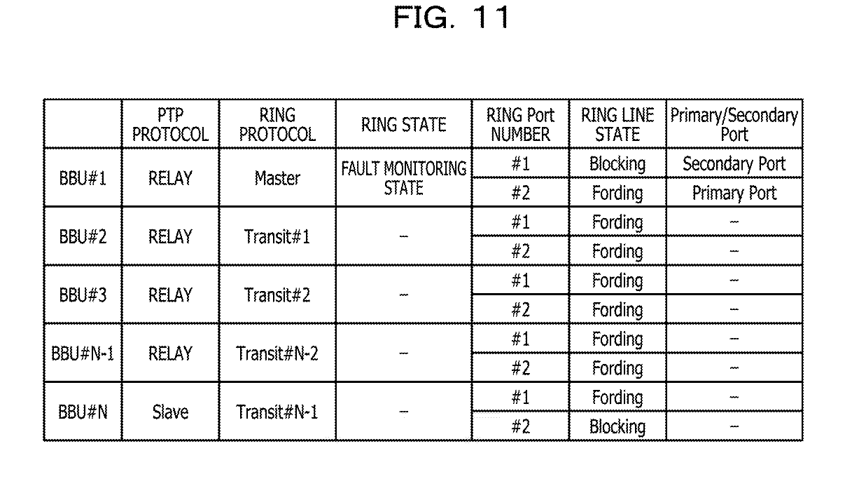

The BBU #1 (master node in the ring protocol) has the management table. FIG. 11 illustrates an example of data structure of a management table and an example of initial setting information. The management table includes an entry for each node forming the ring.

The entry includes a “PTP protocol,” a “ring protocol,” a “ring state,” a “ring port number,” a “ring line state,” and a “primary/secondary port” corresponding to the node (BBU). The ring master manages these pieces of information.

The “PTP protocol” indicates a type (role) of the node in the PTP protocol. That is, as the “PTP protocol,” information is stored which indicates whether the node (BBU) operates as a “relay” or a “slave.” The information may be for example a flag, or may be a code indicating a “relay” or a “slave.”

The “ring protocol” indicates a type (role) of the node in the ring protocol. That is, as the “ring protocol,” information is stored which indicates whether the node (BBU) operates as the ring master in the ring protocol or operates as a “transit” having a given number. The information may be for example a flag, or may be a code indicating a “master” or a “transit (number).”

The “ring state” is information indicating one of a fault monitoring state at a time of normal operation and a recovery monitoring state at a time of occurrence of a fault. The information may be a flag or a code, as described above.

The “ring port number” indicates the number of a port used for the ring coupling among a plurality of external line ports provided to the BBU. The “ring line state” indicates the state of a line identified by the ring port number. The state of the line is indicated by one of blocking and forwarding. The blocking is a line state in which the health check frame and the control frames are allowed to pass through and frames other than these frames are blocked. The forwarding allows the health check frame and frames other than the health check frame to pass through.

The “primary/secondary port” (referred to also as a primary/secondary specifying unit) is information indicating whether the port (line) identified by the ring port number is either a primary port or a secondary part.

The information as illustrated in FIG. 11 is set in the management table to form a ring network as illustrated in FIG. 10. That is, as for the “PTP protocol,” settings are made such that the BBU #N in the last stage is the PTP slave. As for the “ring protocol,” settings are made such that the BBU #1 is the ring master and the BBUs #2 to #N are the transits #1 to #N-1.

In addition, in the entry of the BBU #1 set as the ring master, one of two ports for the ring protocol which ports are provided to the BBU #1 is set as a “primary port,” and the other is set as a “secondary port.” In addition, the primary port of the master node is set to “forwarding,” and the secondary port is set to “blocking.” In addition, the BBU #N has a port #1 set to “forwarding,” and has a port #2 set to “blocking.” Ports for the ring protocol which ports are provided to each of the remaining transit nodes are set to “forwarding.”

Then, the “ring state” in the entry of the BBU #1 (ring master) is set to “fault monitoring.” The setting is made to monitor the state of the ring on the basis of whether or not the health check frame transmitted from the primary port can be received by the secondary port.

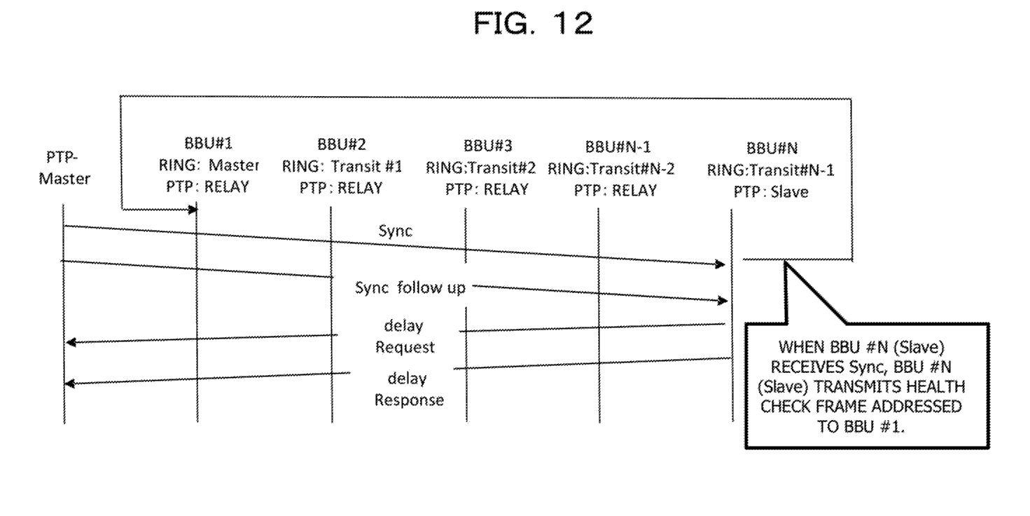

FIG. 12 illustrates a route of passage of a health check frame in the network system illustrated in FIG. 10. The health check frame is used as a method of monitoring a fault in the ring. However, PTP frames (PTP packets) are used as the health check frame for a part of the transfer path of the health check frame in the example of FIG. 7.

In the configuration of the network system illustrated in FIG. 10, PTP packets transmitted and received between the PTP master (PTP-MASTER) and the BBU #N as the slave go through the, primary port of the BBU #1. The continuity of the PTP packets on the transfer path can therefore be confirmed. On the other hand, the PTP packets do not pass between the BBU #N and the BBU #1. It is therefore difficult to confirm continuity between the BBU #N and the BBU #1.

Therefore, as illustrated in FIG. 12, when the BBU #N as the PTP slave receives the Sync message from the PTP master, the BBU #N transmits the health check frame to the BBU #1 (ring master). The BBU #1 (ring master) determines that the ring network is normal by receiving the health check frame.

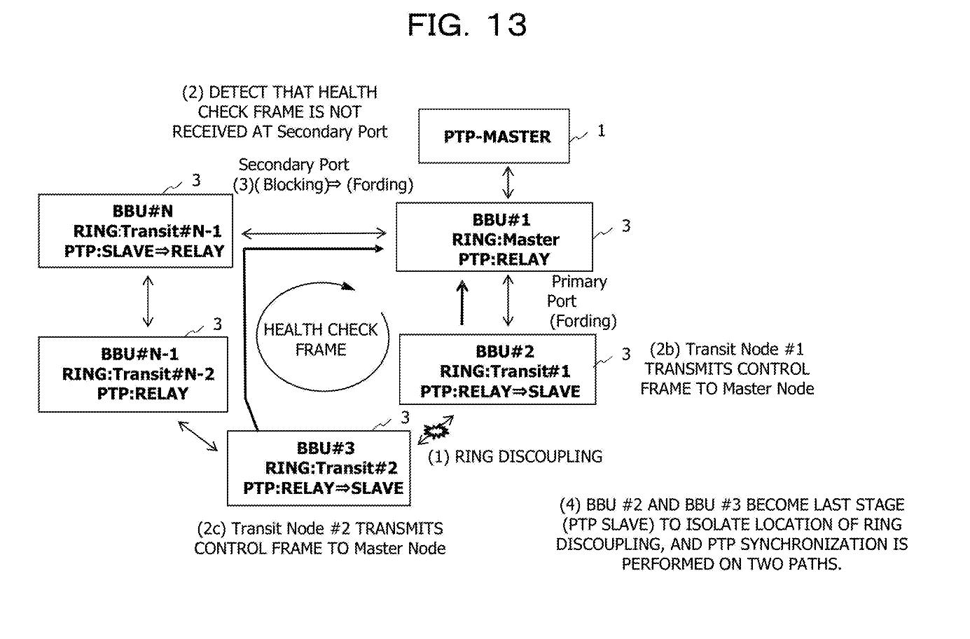

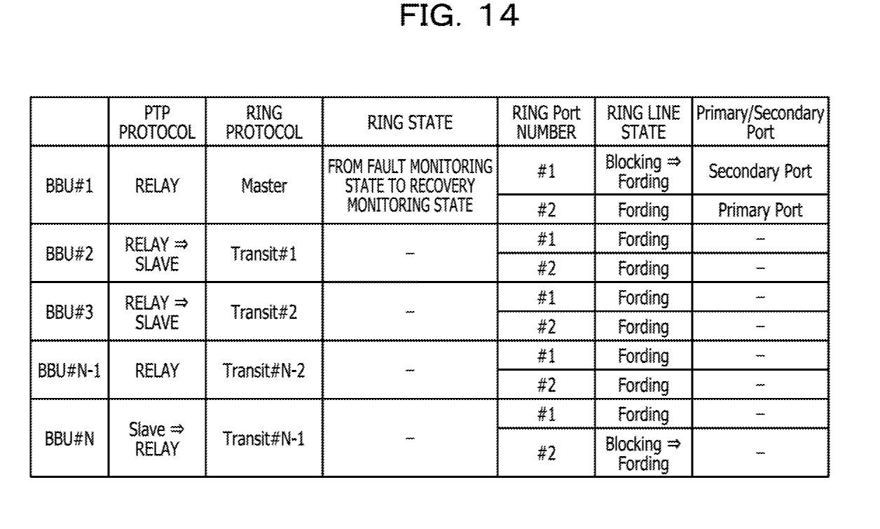

FIG. 13 illustrates behavior at a time of occurrence of a ring discoupling in an example of the network system (ring network) illustrated in FIG. 10. FIG. 14 illustrates contents registered (transitions of stored contents) in a management table at a time of occurrence of a fault.

The ring network is normal while the BBU #1 (ring master) is receiving the health check frame at the secondary port. On the other hand, when a fault occurs in the ring network (FIG. 13(1)), the BBU #1 (ring master) becomes unable to receive the health check frame at the secondary port. On the basis of this, the BBU #1 detects the fault (FIG. 13(2a)). In the example of FIG. 13, the ring is discoupled due to a link fault (broken link) between the BBU #2 and the BBU #3.

The discoupling of the ring is detected by each of the BBU #2 (transit #1) and the BBU #3 (transit #2) housing the link. Each of the BBU #2 (transit #1) and the BBU #3 (transit #2) transmits a control frame indicating the ring fault to the BBU #1 (ring master) (FIGS. 13(2b) and (2c)). The BBU #1 (ring master) can identify the location of the fault on the basis of information included in the control frames. The control frames are an example of “control information received at a time of a fault in the ring.”

After the BBU #1 (ring master) detects the ring discoupling, and identifies the location of the fault on the basis of the control frames, the BBU #1 changes the secondary port from the blocking state to the forwarding state (FIG. 13(3)). Thus, frames addressed to the BBU #3 that becomes a new PTP slave are transmitted to the BBU.

In addition, the BBU #1 changes the PTP slave. That is, when the BBU #1 identifies the location of the fault (location of the ring discoupling) between the BBU #2 and the BBU #3, the BBU #1 provides the PTP master with a notification for changing each of the BBU #2 and the BBU #3 (transmission sources of the control frames) to the PTP slave. As a result of the notification, PTP messages addressed to each of the BBU #2 and the BBU #3 as the PTP slaves are transmitted from the PTP master. The BBU #2 and the BBU #3 are an example of a “second node among the plurality of nodes, the second node being determined on the basis of the location of the fault.” The BBU #2 is an example of a “node discoupled from the first node due to the occurrence of the fault in the ring.” The BBU #3 is an example of a “node coupled to the first node even after the occurrence of the fault in the ring.”

In addition, the BBU #1 (ring master) may for example send a notification to the BBU #2 and the BBU #3 to make to the BBU #2 and the BBU #3 operate as slaves, and send a notification to the BBU #N to make the BBU #N operate as a relay node. However, the transmission of the above-described notifications can be omitted in a case where settings are made in each BBU in advance so as to make each BBU operate as a relay node when the PTP messages are not addressed to the BBU itself or operate as a PTP slave when the PTP messages are addressed to the BBU itself. In addition, the BBU #1 (ring master) changes the ring state from the fault monitoring state to the recovery monitoring state.

As for the health check, the BBU #1 (ring master) instructs the BBU #2 such that the BBU #2 that becomes a new PTP slave transmits the health check frame addressed to the BBU #1 toward the BBU #3 with the reception of a PTP message (for example Sync) as a trigger. In the present example, of the two PTP slaves, that is, the BBU #2 and the BBU #3, the BBU #2 located upstream as viewed from the PTP master before the fault (BBU #2 having a lower number) transmits the health check frame.

The instructing is an example of instructing “the node discoupled from the first node to transmit a health check signal that is to arrive at the relay node via the first node with reception of a time synchronizing signal from the master node as a trigger.”

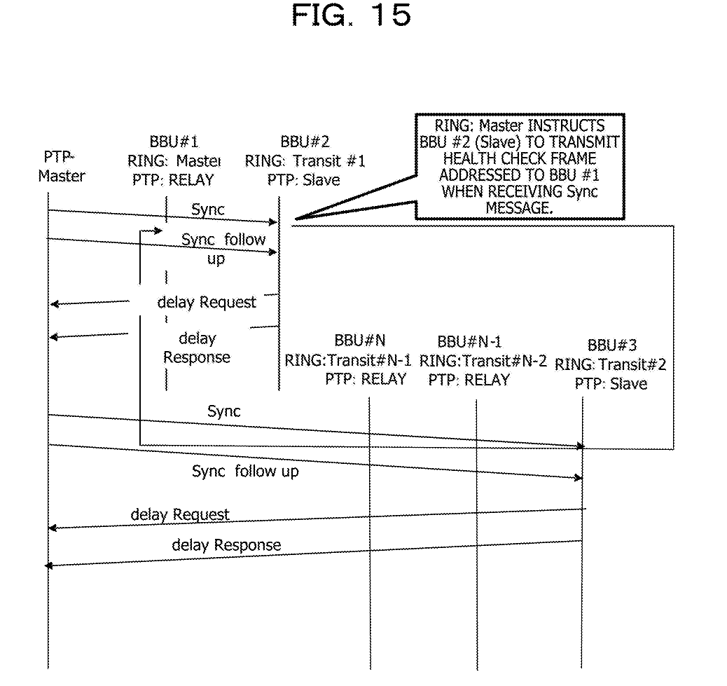

FIG. 15 illustrates a transfer path of a health check message. As described above, because of the change of the PTP slave, PTP messages are exchanged between the BBU #2 and the BBU #3, which are the new PTP slaves, and the PTP master. The BBU #2 transmits the health check frame addressed to the BBU #1 (ring master) toward the BBU #3 with reception of the Sync message as a trigger. While the link is faulty, the health check frame does not arrive at the BBU #3. However, when the link is restored and thus the ring recovers, the health check frame arrives at the secondary port of the BBU #1. The BBU #1 can recognize the recovery of the ring on the basis of the arrival of the health check frame.

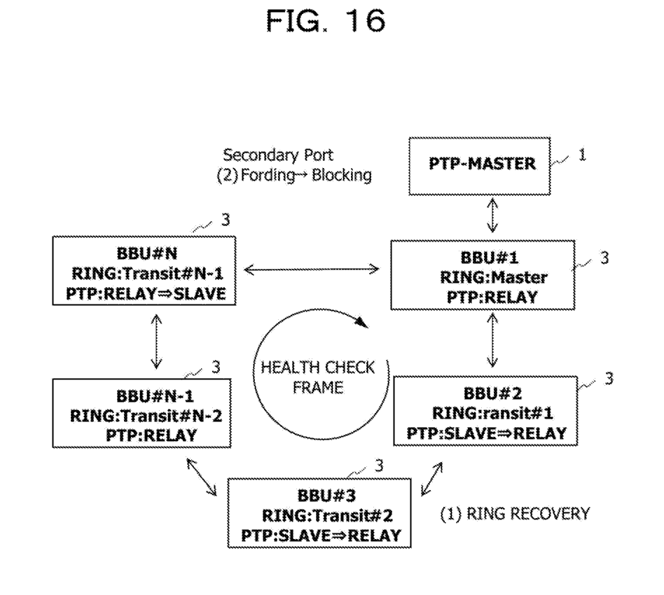

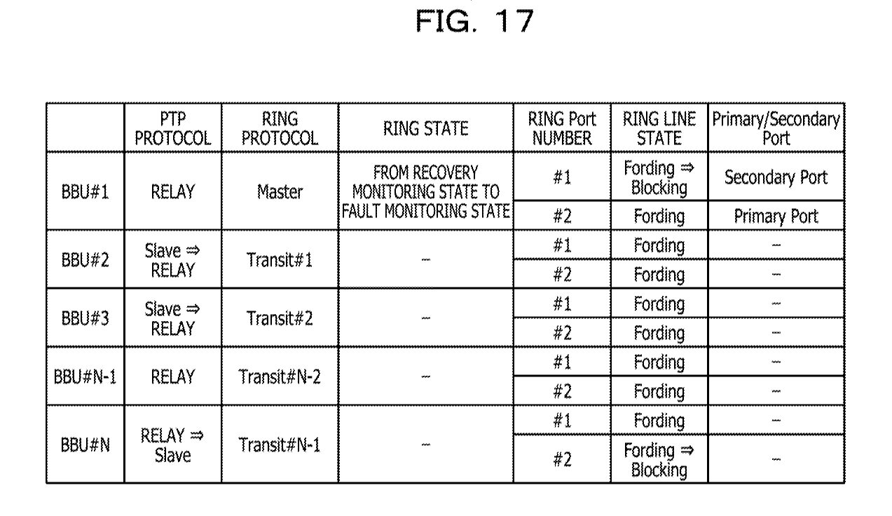

FIG. 16 is a diagram of assistance in explaining an operation at a time of ring recovery. FIG. 17 illustrates contents registered (transitions of stored contents) in a management table at a time of ring recovery. As illustrated in FIG. 16, when the link between the BBU #2 and the BBU #3 is restored and thus the ring recovers, the health check frame transmitted from the BBU #2 passes through the BBU #3, the BBU #N-1, and the BBU #N, and arrives at the secondary port of the BBU #1. The BBU #1 thus recognizes the recovery of the ring.

Then, the BBU #1 changes the state of the secondary port from forwarding to blocking. In addition, the BBU #1 sends a notification for making the PTP master transmit PTP messages addressed to the BBU #N again to the PTP master. Then, notifications are sent to make the BBU #2 and the BBU #3 operate as relay nodes and make the BBU #N operate as the PTP slave. However, the above-described notifications are unnecessary in a case where settings are made such that the BBU #2 and the BBU #3 operate as PTP slaves when the destinations of the PTP messages are the BBU #2 and the BBU #3, or operate as relay nodes when the destinations of the PTP messages are not the BBU #2 and the BBU #3. Then, the BBU #1 (ring master) makes a transition from the recovery monitoring state to the fault monitoring state. As a result of the above, as illustrated in FIG. 17, the contents registered in the management table of the BBU #1 return to the state before the occurrence of the fault.

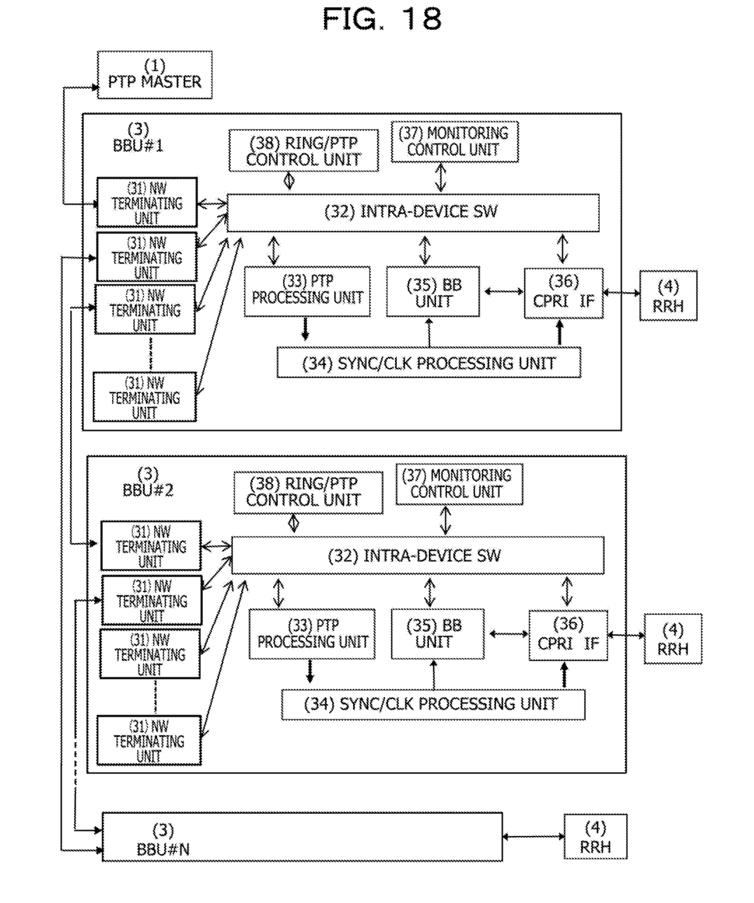

FIG. 18 is a diagram illustrating an example of configuration of each BBU in the embodiment. In FIG. 18, the network system includes the PTP master 1, the plurality of BBUs 3 (BBUs #1 to #N), and RRHs 4 coupled to the respective BBUs 3. A BBU 3 and an RRH 4 form a base station device. However, the relation between the BBUs 3 and the RRHs 4 is not limited to 1:1, but may be 1:N.

The plurality of BBUs 3 have the same configuration. Therefore description will be made by taking the BBU #1 as an example. The BBU #1 includes N network terminating units (NW terminating units) 31, an intra-device switch (intra-device SW) 32, a PTP processing unit 33, a synchronization/clock processing unit (SYNC/CLK processing unit) 34, a baseband (BB) unit 35, a Common Public Radio Interface (PRI) interface (CPRI IF) 36, a monitoring control unit 37, and a ring/PTP control unit 38.

Each NW terminating unit 31 (NW terminating units #1 to #N) transmits and receives various kinds of packets to and from a higher-level network (not illustrated), other BBUs 3, and the PTP master 1. For example, when the base station device operates as a base station (eNB) in Long Term Evolution (LTE), the higher-level network is a core network in LTE. However, radio communication standards that the base station device conforms to or complies with may be standards other than LTE.

Further, the NW terminating units 31 included in the BBU #1, the BBU #2, and the BBU #3 perform processing of adding the transmission and reception times (residence times) of a PTP packet to the Correction field at a time of transparent clocks (when operating as relay nodes).

The intra-device SW performs packet switching for transmission and reception of packets between the blocks within the BBU 3 (between the NW terminating units 31, the PTP processing unit 33, the BB unit 35, the CPRI IF 36, the ring/PTP control unit 38, and the monitoring control unit 37).

The PTP processing unit 33 controls operations as the PTP slave. The PTP processing unit 33 extracts time information (time stamps) by transmitting and receiving PTP packets as the PTP slave. In addition, the PTP processing unit 33 performs synchronization establishment processing when operating as a relay node.

The synchronization/clock processing unit 34 generates a reference dock and timing in accordance with the time information obtained by exchanging the PTP messages. The BB unit 35 performs conversion processing between data as an object of radio communication and a baseband signal. The CPRI IF 36 converts the baseband signal into a CPRI signal, and sends the CPRI signal to the RRH 4. In addition, the CPRI IF 36 converts a CPRI signal received from the RRH 4 into a baseband signal.

The monitoring control unit 37 monitors and controls processing or operation within the BBU 3, and communicates with the RRH 4 and higher-level devices. The ring/PTP control unit 38 performs PTP slave changing processing so as to follow operation based on the ring protocol at a time of occurrence of a fault in the ring. The management table is managed by the ring/PTP control unit 38. The ring/PTP control unit 38 is an example of a “control unit.”

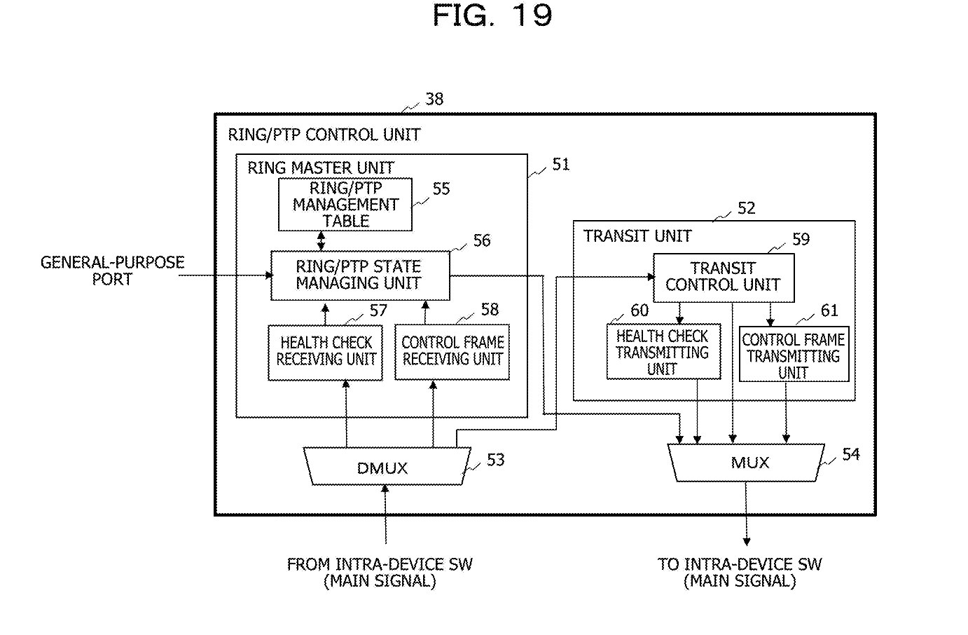

FIG. 19 is a diagram illustrating an example of configuration of a ring/PTP control unit. The ring/PTP control unit illustrated in FIG. 19 may be the ring/PTP control unit 38 illustrated in FIG. 18. In the example illustrated in FIG. 19, the ring/PTP control unit 38 includes a ring master unit 51, a transit unit 52, a demultiplexer (DMUX) 53, and a multiplexer (MUX) 54.

The ring master unit 51 includes a ring/PTP management table (management table) 55, a ring/PTP state managing unit 56, a health check receiving unit 57, and a control frame receiving unit 58. The transit unit 52 includes a transit control unit 59, a health check transmitting unit 60, and a control frame transmitting unit 61.

The management table 55 stores information on initial settings corresponding to the form of the network, which information is input from a general-purpose port. The ring/PTP state managing unit (hereinafter denoted also as a “state managing unit”) 56, for example, reads and writes the information from and to the management table 55.

In a case where the BBU 3 operates as the ring master, the state managing unit 56 controls the operation of the BBUs 3 operating as transit nodes within the ring network on the basis of the information stored in the management table 55. The control of the BBUs 3 is performed by sending a main signal including a signal and information for BBU control to the target BBUs 3 via the intra-device SW 32. The state managing unit 56 manages the management table 55 (reads and writes (updates) information from and to the management table 55).

In the case where the BBU 3 operates as the ring master, the health check receiving unit 57 checks the health check frame received from the secondary port. The health check receiving unit 57 determines that a fault has occurred in the ring when the health check receiving unit 57 has not received the health check frame for a certain time.

When a fault has occurred within the ring network, the control frame receiving unit 58 receives control frames transmitted by BBUs 3 (transits) detecting the fault, and notifies the control frames to the state managing unit 56. The state managing unit 56 identifies the location of the fault on the basis of information included in the control frames, and changes a route within the ring.

The transit unit 52 includes the transit control unit 59, the health check transmitting unit 60, and the control frame transmitting unit 61. The transit control unit 59 controls the operation of the health check transmitting unit 60 and the control frame transmitting unit 61 using a signal (instruction) from the ring master which signal is input from the intra-device SW via the DMUX 51

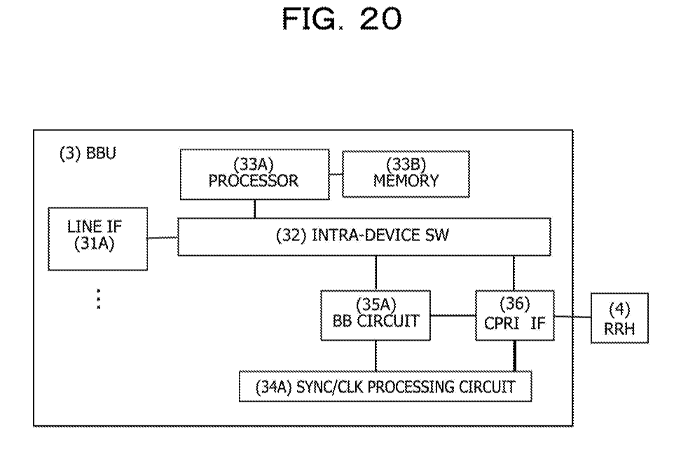

In a case where the BBU 3 operates as the PTP slave, the health check transmitting unit 60 transmits the health check frame to the ring master with reception of the PTP Sync message as a trigger on the basis of an instruction from the ring master. When there are two or more PTP slaves within the ring, the ring master selects the slave that is to transmit the health check frame, and provides the slave with an instruction to transmit the health check frame. In the present embodiment, a 88U 3 (transit) having a lower number is selected as the slave that is to transmit the health check frame. The control frame transmitting unit 61 transmits the control frame addressed to the ring master when a line interface unit (line IF) 31A (FIG. 20) detects a fault.

The DMUX 53 separates main signals. Of the main signals received by the DMUX 53, a health check signal is sent to the health check receiving unit 57 of the ring master unit 51. In addition, control frames in the main signals are sent to the control frame receiving unit 58 of the ring master unit 51. Signals other than the health check signal and the control frames are sent to the transit control unit 59 of the transit unit 52. The MUX 54 multiplexes and outputs a signal transmitted from the transit control unit 59, a signal transmitted from the state managing unit 56, the health check frame transmitted from the health check transmitting unit 60, and the control frame transmitted from the control frame transmitting unit 61.

FIG. 20 is a diagram illustrating an example of hardware configuration of a 8BU. The 88U illustrated in FIG. 20 may be the BBU 3 illustrated in FIG. 5. In FIG. 20, the BBU 3 includes one or more line IFs 31A, an intra-device SW 32, a processor 33A, a memory 33B, a SYNC/CLK processing circuit 34A, a 88 circuit 35A, and a CPRI IF 36. The processor 33A is an example of a “control unit,” a “control device,” or a “controller.”

The line IF 31A is an interface circuit operating as an NW terminating unit 31 illustrated in FIG. 18. The line IF 31A houses and terminates a line of a Local Area Network (LAN), Internet Protocol (IP), or the like. The memory 33B stores a program executed by the processor and data used when the program is executed. The memory 33B includes a main storage device and an auxiliary storage device.

The main storage device is for example a Random Access Memory (RAM) or a combination of a RAM and a Read Only Memory (ROM). The RAM is used as a work area for the processor, an area for expanding a program, and a data buffer area. The ROM stores a program (embedded program such as firmware or the like) and data. The auxiliary storage device is used as a storage area for programs and data. The auxiliary storage device includes a hard disk (HDD), a Solid State Drive (SSD), a flash memory, an Electrically Erasable Programmable Read-Only Memory (EEPROM), and the like.

The processor 33A loads and executes a program stored in the memory 33B. The processor 33A thereby operates as the monitoring control unit 37, the ring/PTP control unit 38, and the PTP processing unit 33. The processor 33A is for example a Central Processing Unit (CPU), a Digital Signal Processor (DSP), a combination of a CPU and a DSP, or the like.

The BB circuit 35A is a circuit operating as the BB unit 35. The SYNC/CLK processing circuit 34A is a circuit operating as the SYNC/CLK processing unit 34. The BB circuit 35A, the CPRI IF 36, and the SYNC/CLK processing circuit 34A are for example formed by a DSP, a semiconductor device, or a combination of a DSP and a semiconductor device. The semiconductor device includes for example a programmable logic device (PLD) such as a Field Programmable Gate Array (FPGA) or the like, an integrated circuit (an IC, a Large-Scale Integration (LSI), or an Application Specific Integrated Circuit (ASIC)), electric and electronic circuits, or the like.

Incidentally, the processing of the monitoring control unit 37, the ring/PTP control unit 38, and the PTP processing unit 33 may be performed by the above-described semiconductor device, for example. In addition, at least a part of the processing of the SYNC/CLK processing unit 34 can be performed by software processing.

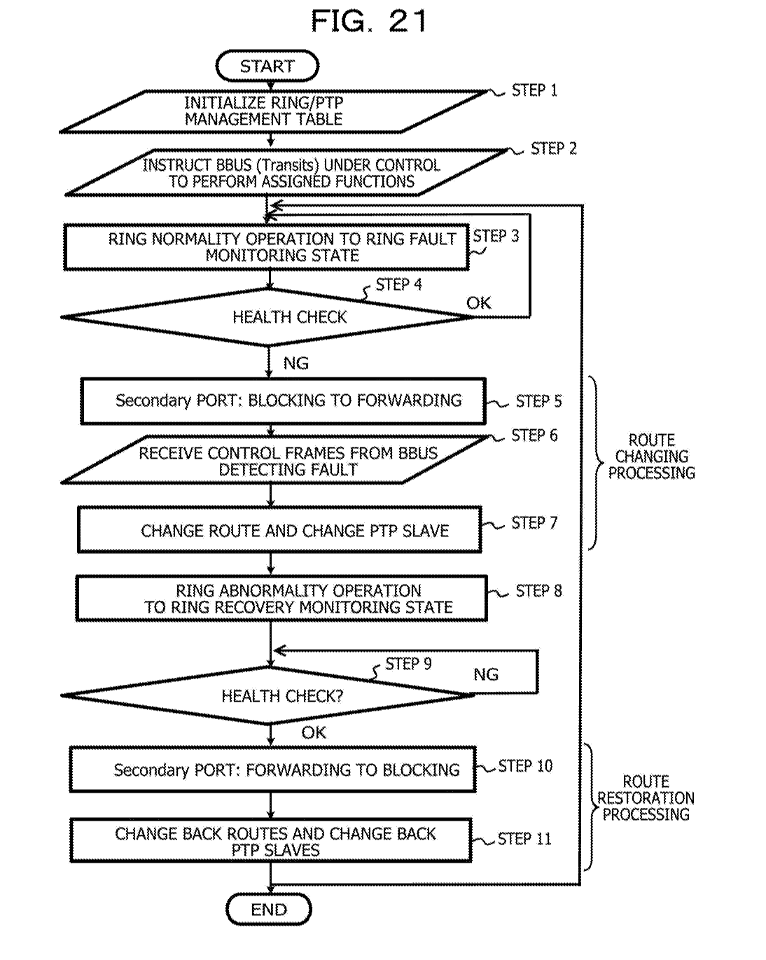

FIG. 21 is a flowchart illustrating an example of processing in a ring master. The processing of FIG. 21 is for example performed by the processor 33A of the BBU 3 operating as the ring master (for example the BBU #1 in FIG. 10). In step (Step) 1 in FIG. 21, the ring master unit 51 initializes the management table 55 (see FIG. 11).

In step 2, the ring master unit 51 instructs the BBUs 3 under control of the ring master unit 51 (for example the BBUs #2 to #N in FIG. 10) to perform assigned functions. That is, the state managing unit 56 of the ring master unit 51 sends instructions indicating the assignment of functions (role: “relay” or “slave”) to the other BBUs 3 on the basis of the initial settings of the “PTP protocol” set in the management table 55. According to the instructions, each of the BBUs 3 operates as one of a “relay” and a “slave.”

In step 3, on the basis of the operation mode “ring fault monitoring state,” the state managing unit 56 of the ring master unit 51 makes a health check determination (OK or NG) based on the presence or absence of the health check signal from the slave (BBU #N: FIG. 10) (step 4). When a result of the determination is OK, the processing returns to step 3. When the result of the determination is NG, the processing proceeds to step 5.

In step 5, the state managing unit 56 of the ring master unit 51 changes the secondary port from the blocking state to the forwarding state (see FIG. 14). In step 6, the state managing unit 56 of the ring master unit 51 receives control frames from BBUs 3 detecting a fault in the ring, and identifies the location of the fault in the ring.

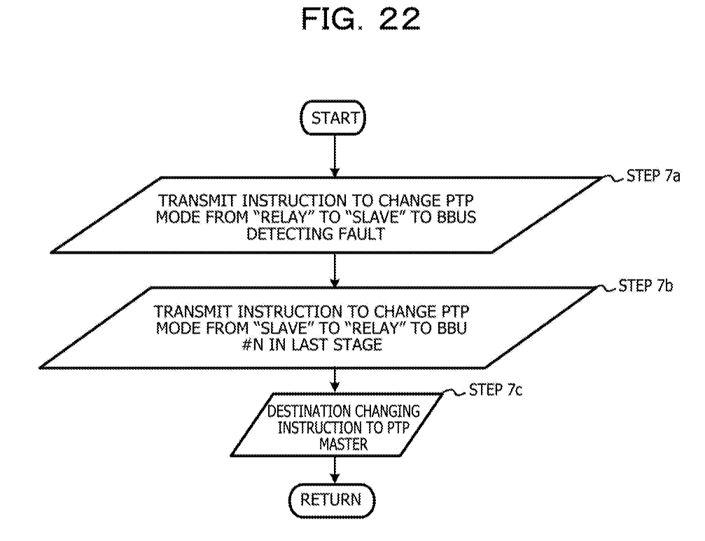

In step 7, processing of changing the route of PTP messages (PTP packets) and the PTP slave is performed. FIG. 22 is a flowchart illustrating a detailed example of step 7. In step 7a, the state managing unit 56 generates an instruction (message) to change a PTP mode (assigned functions) from “relay” to “slave,” and transmits the instruction to the BBUs detecting the fault (BBUs 3 as transmission sources of the control frames). Consequently, for example, each of the BBU #2 and the BBU #3 illustrated in FIG. 10 changes from “relay” to “slave.”

In step 7b, the state managing unit 56 generates an instruction (message) to change the PTP mode (assigned functions) from “slave” to “relay,” and transmits the instruction to the BBU #N in the last stage (BBU 3 that has operated as the slave). Consequently, for example, the BBU #N illustrated in FIG. 10 changes from “slave” to “relay.”

In step 7c, the state managing unit 56 generates a message instructing the FTP master to change the destination of FTP messages from the BBU #N to the BBU #2 and the BBU #3, and transmits the message to the PTP master. As a result of the route changing processing of steps 5 to 7 as described above, the FTP slave and the destination of FTP messages are changed, and time synchronization based on PTP in each BBU 3 is continued (FIG. 13). Incidentally, the order of steps 7a, 7b, and 7c can be changed as appropriate.

The processing of steps 7a and 7b is an example of processing of “sending an instruction to operate as the slave node to the second node, and transmitting, to the first node, an instruction to transfer the time synchronizing signals from the master node to the second node.”

In addition, the processing of step 7c is an example of processing of “sending, to the master node, an instruction to change a destination of the time synchronizing signals addressed to the slave node from the first node to a second node among the plurality of nodes, the second node being determined on the basis of the location of the fault.”

Returning to FIG. 21, the state managing unit 56 in step 8 updates the ring state of the management table 55 to recovery monitoring (FIG. 14), and changes the operation of the ring master to the recovery monitoring state.

In step 9, the state managing unit 56 performs a health check of the ring. That is, the state managing unit 56 determines whether or not the ring has recovered from the fault on the basis of determining whether or not the health check frame is received from the BBU 3 that has become a new transmission source of the health check frame (BBU #2 in the example of FIG. 10).

When the health check in step 9 indicates NG, that is, while the health check frame from the BBU #2 is not received (health check NG), it means that the ring fault between the BBU #2 and the BBU #3 is not resolved. When the health check frame is received (health check OK), on the other hand, the processing proceeds to step 10.

In step 10, the state managing unit 56 changes the state of the secondary port from forwarding to blocking (FIG. 17). In step 11, processing of changing back the routes and the PTP slaves is performed.

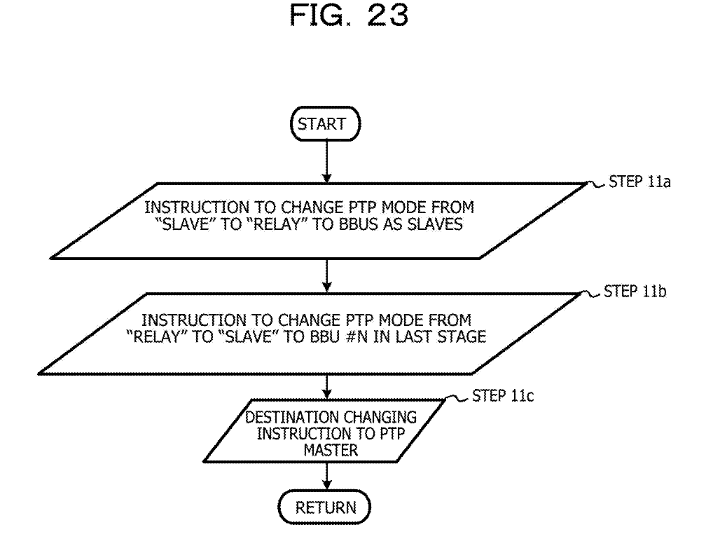

FIG. 23 is a flowchart illustrating an example of processing of changing back PTP routes and PTP slaves. As illustrated in FIG. 23, the state managing unit 56 transmits an instruction to change back the PTP mode (from “slave” to “relay”) to each of the BBUs 3 operating as slaves (the BBU #2 and the BBU #3) (step 11a).

The state managing unit 56 transmits an instruction to change back the PTP mode (from “relay” to “slave”) to the BBU 3 whose PTP mode is changed to the relay at the time of the ring fault (BBU #N) (step 11b). The state managing unit 56 gives an instruction to change the destination of PTP messages to the original BBU #N to the PTP master (step 11c). Incidentally, the order of steps 11a, 11b, and 11c can be changed as appropriate.

The processing of steps 11a and 11b is an example of processing of “sending an instruction to operate as the slave node to the first node, and transmitting, to the second node, an instruction to transfer the time synchronizing signals from the master node to the first node.”

The processing of step 11c is an example of processing of “transmitting, to the master node, an instruction to change the destination of the time synchronizing signals addressed to the slave node from the second node to the first node when the health check signal is received.”

The route restoration processing of steps 9 to 11 as described above returns the routes of PTP messages and the FTP slaves to the states before the ring fault. Incidentally, in the ring master (BBU #1), the state managing unit 56 changes the ring state from the recovery monitoring state to the fault monitoring state (see FIG. 16 and FIG. 17).

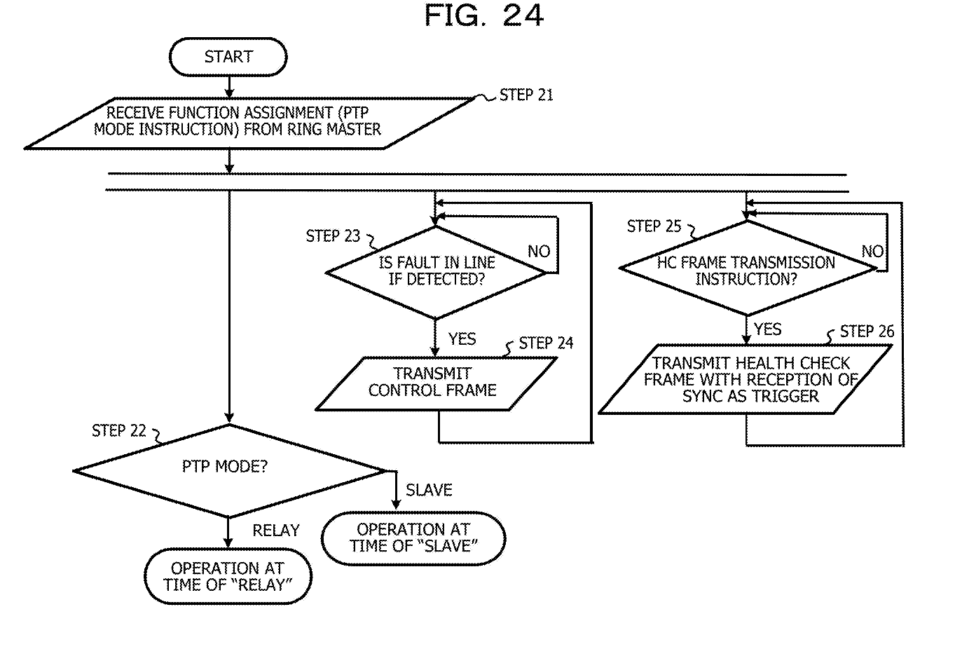

FIG. 24 is a flowchart illustrating an example of processing in a transit in a ring. The processing illustrated in FIG. 24 is for example performed by the transit unit 52 (processor 33A) of a BBU 3 operating as a transit in the ring.

In step 21 in FIG. 24, the transit control unit 59 of the transit unit 52 receives a function assignment (PTP mode instruction) from the ring master, and operates in a PTP mode according to the instruction.

In step 22, the transit control unit 59 determines the PTP mode of itself when a main signal is received. When the PTP mode is “Slave,” the transit control unit 59 operates as a slave. When the PTP mode is “relay,” the transit control unit 59 operates as a relay.

When the transit control unit 59 detects a fault in the line IF 31A in step 23 (Y in step 23), the control frame transmitting unit 61 transmits a control frame to the ring master (step 24).

When the transit control unit 59 detects an instruction to transmit the health check (HC) frame in step 25 (Y in step 25), the health check transmitting unit 60 transmits the health check frame with reception of the Sync message as a trigger (step 26).

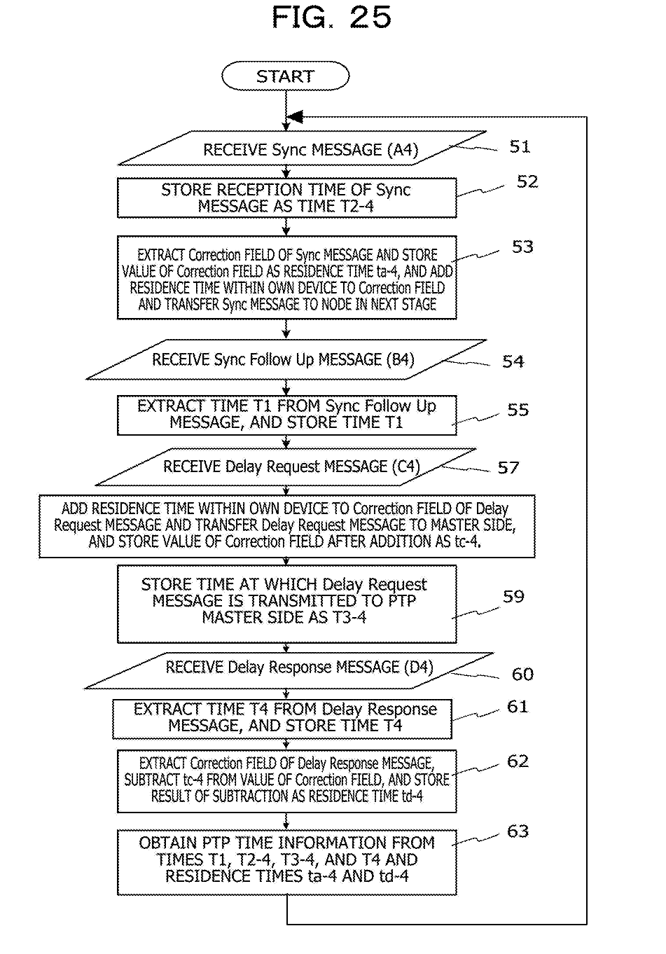

FIG. 25 is a flowchart illustrating an example of operation as a “relay.” The processing illustrated in FIG. 25 is for example performed by the processor 33A of a BBU 3 operating as a “relay.” As an example, assume that the BBU 3 operating as a “relay” is the BBU #N-1 in FIG. 6.

In step 51, the processor 33A of the BBU #N-1 receives a Sync message from the PTP master (A4 in FIG. 6). In step 52, the processor 33A stores the reception time of the Sync message as a time “T2-4” in the memory 338. In step 53, the processor 33A extracts the value of the Correction field of the Sync message, and stores the value as a residence time “ta-4.” In addition, the processor 33A adds a residence time within the own device to the Correction field, and then transfers the Sync message to the node in the next stage.

In step 54, the processor 33A of the BBU #N-1 receives a Sync follow up message from the PTP master (64 in FIG. 6). In step 55, the processor 33A extracts a time (time stamp) “T1” from the Sync follow up message, and stores the time T1 in the memory 33B.

In step 57, the processor 33A of the BBU #N-1 receives a Delay Request message from the PTP slave (BBU #N) (C4 in FIG. 6). In step 58, the processor 33A adds a residence time within the own device to the Correction field of the Delay Request message, and then transfers the Delay Request message to the master side. In addition, the processor 33A stores the value of the correction field after the addition as tc-4. In step 59, the processor 33A stores, as a time “T3-4,” a time at which the Delay Request message is transmitted to the PTP master side.

In step 60, the processor 33A of the BBU #N-1 receives a Delay Response message from the PTP master (D4 in FIG. 6). In step 61, the processor 33A stores a time (time stamp) T4 in the Delay Response message in the memory 33B. In step 62, the processor 33A stores a result of subtracting the residence time “tc-4” from the value of the Correction field of the Delay Response message as a residence time “td-4” in the memory 336.

In step 63, the processor 33A obtains PTP time information (offset) from the time T1, the time T2-4, the time T3-4, the time T4, the residence time ta-4, and the residence time td-4. Incidentally, the SYNC/CLK processing circuit 34A synchronizes the clock and timing of the BBU #N-1 with the PTP master on the basis of the PTP time information.

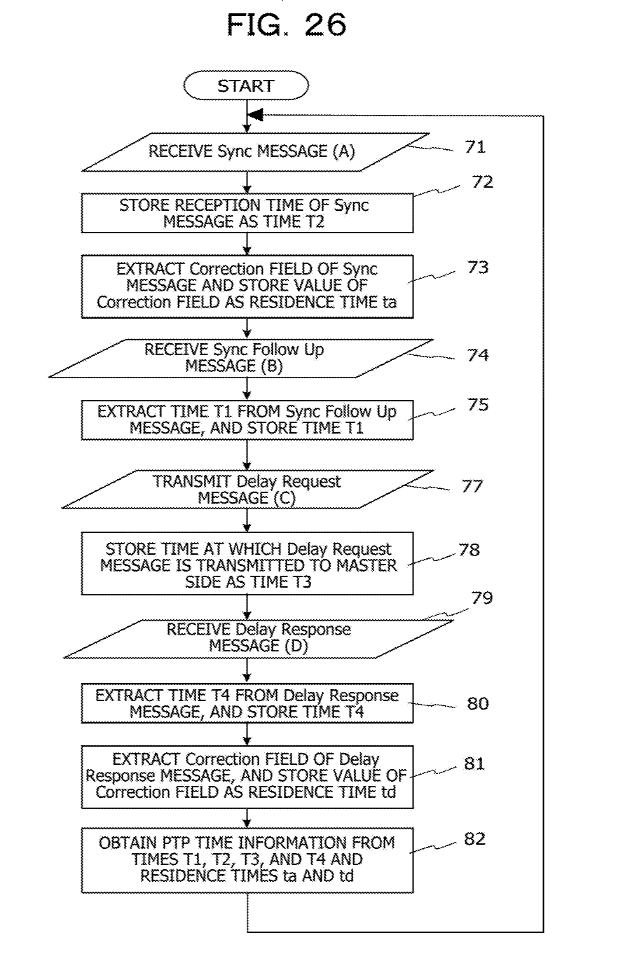

FIG. 26 is a flowchart illustrating an example of operation as a “slave.” The processing illustrated in FIG. 26 is for example performed by the processor 33A of a BBU 3 operating as a “slave.” As an example, assume that a BBU 3 operating as a “slave” is the BBU #N in FIG. 6.

In step 71, the processor 33A of the BBU #N receives a Sync message from the PTP master (A in FIG. 6). In step 72, the processor 33A stores the reception time of the Sync message as a time “T2” in the memory 338. In step 73, the processor 33A extracts the value of the Correction field of the Sync message, and stores the value as a residence time “ta.”

In step 74, the processor 33A of the BBU #N receives a Sync follow up message from the PTP master (B in FIG. 6). In step 75, the processor 33A extracts the time (time stamp) “T1” from the Sync follow up message, and stores the time T1 in the memory 338.

In step 77, the processor 33A of the BBU #N-1 receives a Delay Request message from the PTP slave (BBU #N) (C in FIG. 6). In step 78, the processor 33A stores a time at which the Delay Request message is transmitted to the PTP master side as a time “T3.”

In step 79, the processor 33A of the BBU #N receives a Delay Response message from the PTP master (D4 in FIG. 6). In step 80, the processor 33A stores the time (time stamp) T4 in the Delay Response message in the memory 33B. In step 81, the processor 33A stores the value of the Correction field of the Delay Response message as a residence time “td” in the memory 33B.

In step 82, the processor 33A obtains PTP time information (offset) from the time T1, the time T2, the time T3, the time T4, the residence time ta, and the residence time td. Incidentally, the SYNC/CLK processing circuit 34A synchronizes the clock and timing of the BBU #N with the PTP master on the basis of the PTP time information.

According to the first embodiment, the nodes (BBUs 3) relaying the PTP messages transmitted and received between the PTP master and the slave intercept the PTP messages, and perform time synchronization with the PTP master. It is therefore unnecessary to transmit and receive PTP messages between each node and the PTP master. It is thereby possible to shorten time taken for the plurality of BBUs 3 to achieve PTP synchronization. In addition, because PTP messages are not transmitted and received to or from each of the BBUs 3, the amount of PTP packets transmitted to the network is reduced, so that a load on the network can be reduced.

In addition, according to the first embodiment, each BBU 3 serving as a “relay” or a “slave” with respect to the PTP master forms a ring. The BBU 3 (BBU #1) as the ring master performs the processing of changing the route (path) of the PTP messages and the PTP slave at a time of detection of a ring fault. This enables each BBU 3 to achieve PTP synchronization even at the time of the ring fault.

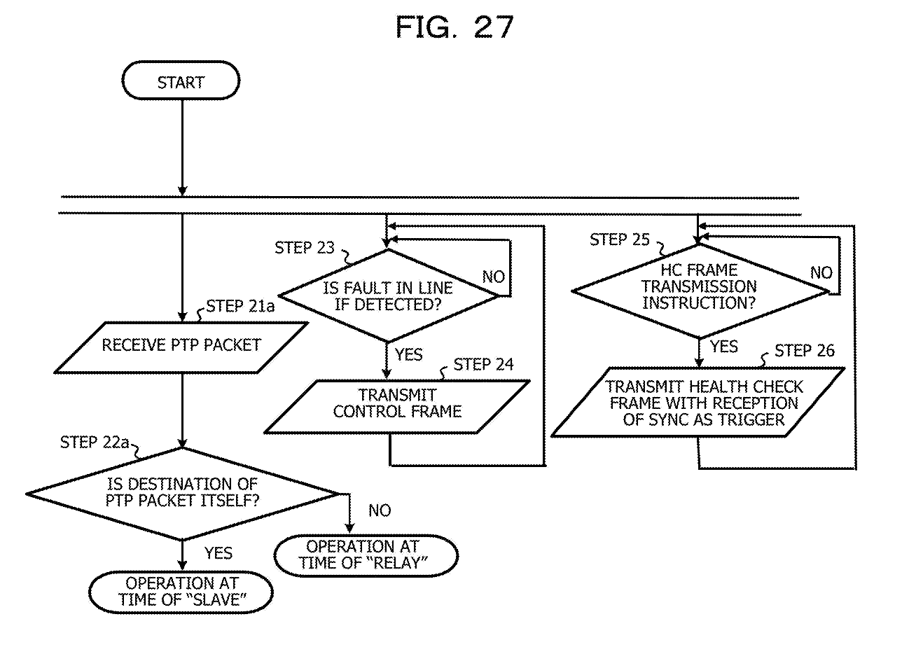

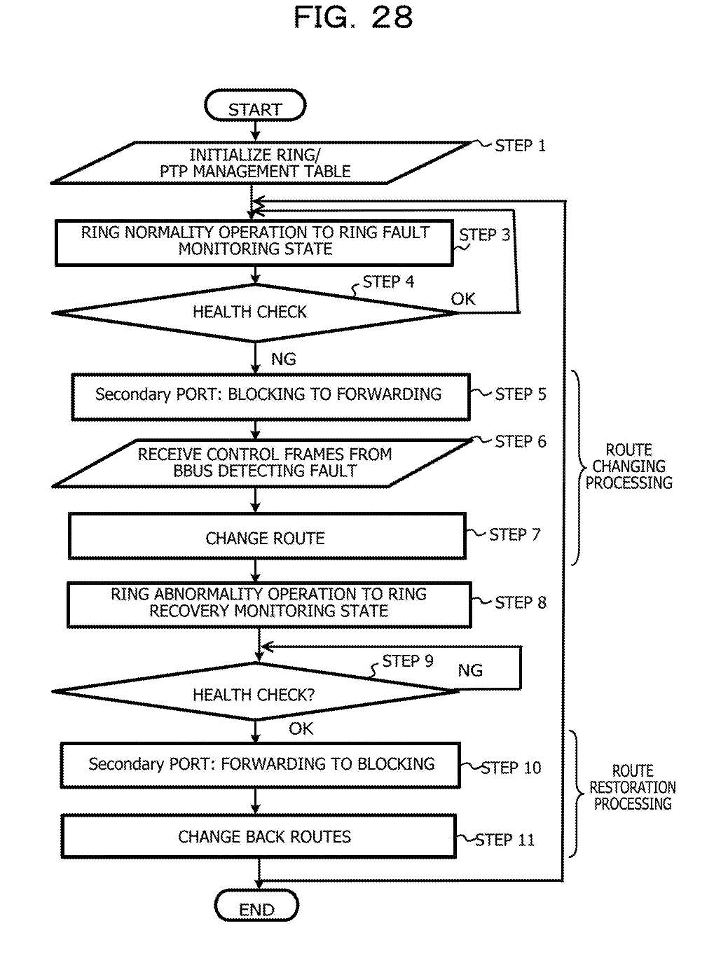

FIG. 27 and FIG. 28 are flowcharts illustrating a modification of the first embodiment. Incidentally, in the example of operation of the embodiment described above, the BBU 3 as the ring master gives an instruction about the PTP mode (“relay” or “slave”) in which to operate to the transit BBUs 3. On the other hand, each of the BBUs 3 may perform processing as in a modification illustrated in FIG. 27.

In step 21a, when receiving a PTP packet, the BBU 3 determines whether or not the destination of the PTP packet is the BBU 3 itself (step 22a). Then, when the destination of the PTP packet is the BBU 3 itself (YES in step 22a), the BBU 3 performs operation as a “slave” (FIG. 26). When the destination of the PTP packet is not the BBU 3 itself (NO in step 22a), on the other hand, the BBU 3 performs operation as a relay (FIG. 25).

In this case, as illustrated in FIG. 28, step 2 can be omitted. Also in step 7 and step 11, PTP mode changing instructions (steps 7a and 7b) and changing-back instructions (steps 11a and 11b) transmitted to each of the BBUs 3 are unnecessary.

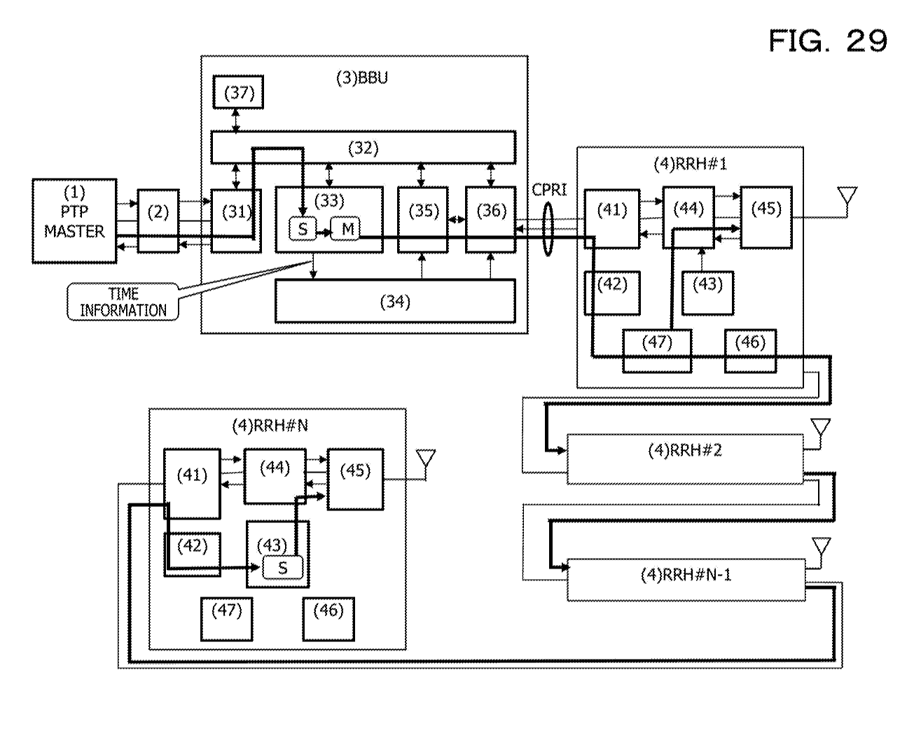

FIG. 29 is a diagram illustrating an example of configuration of a second embodiment. The second embodiment has a configuration in common with the first embodiment. Therefore, description will be made mainly of differences, and description of commonalities will be omitted.

In a network system according to the second embodiment, a PTP master 1 and a plurality of BBUs 3 are coupled to each other in a star topology via a switching hub (hub) 2. For example, the coupling relation between the PTP master and each BBU 3 as illustrated in FIG. 3 is provided. However, FIG. 29 illustrates only one of the plurality of BBUs 3. Numbers in parentheses within respective blocks in FIG. 29 represent reference numerals given to the respective blocks.

In the second embodiment, a plurality of (N) RRHs 4 are cascaded to one BBU 3. In the example illustrated in FIG. 29, RRHs #1, #2, #N-1, and #N are coupled in series with each other as the plurality of RRHs

As with the BBUs 3 according to the first embodiment, the BBU 3 includes an NW terminating unit 31, an intra-device SW 32, a PTP processing unit 33, a SYNC/CLK processing unit 34, a BB unit 35, and a CPRI IF 36. These configurations are substantially similar to those of the first embodiment.

The PTP processing unit 33 performs operation as a PTP master and operation as a PTP slave. In FIG. 29, a symbol “S” denoting the PTP slave and a symbol “M” denoting the PTP master are illustrated in the block representing the PTP processing unit 33. The PTP processing unit 33 as the PTP slave transmits and receives PTP packets to and from the PTP master 1 via the intra-device SW 32 and the NW terminating unit 31. Time synchronization with the PTP master 1 is thereby performed. In addition, the PTP processing unit 33 as the PTP master transmits and receives PTP packet information (PTP messages) to and from the RRHs 4 via the CPRI IF (CPRI terminating unit) 36.

The BBU 3 is an example of a “master node.” The RRH #N is an example of a “slave node.” Each of the RRHs #1 to #N-1 is an example of a “communication apparatus.”

The CPRI terminating unit 36 maps PTP messages to a CPRI link coupled to the RRHs 4. The PTP messages are transmitted and received to and from the RRHs 4 via the CPRI. The SYNC/CLK processing unit 34 generates a reference clock and reference timing (synchronized with the PTP master 1) within the BBU 3 on the basis of time information (offset) obtained by the PTP processing unit 33 operating as the PTP slave.

As described above, each of the BBUs 3 in the second embodiment operates as the PTP slave with respect to the PTP master, and generates a reference clock and reference timing synchronized with the PTP master 1. Further, the PTP processing unit 33 operates as the PTP master with respect to each of the cascaded RRHs 4, and transmits and receives PTP messages to and from the RRH 4 (RRH #N) located in a last stage among the plurality of RRHs 4 as a slave. Each of the RRHs 4 located between the BBU 3 and the RRH #N operates as a “relay” node described in the first embodiment, and performs synchronization processing by intercepting the PTP packets transmitted and received between the RRH #N and the BBU 3.

Each RRH 4 has a same configuration. Description will therefore be made by taking the RRH #1 as an example. The RRH 4 (RRH #1) includes a CPRI terminating unit 41, a PTP TC unit 42, a PTP slave unit 43, a delay correcting unit 44, a Radio Frequency (RF) unit 45, a CPRI terminating unit 46, and a PTP relay unit 47.

The CPRI terminating unit 41 extracts a PTP message received via the CPRI with the BBU 3, and sends the PTP message to the PTP TC unit 42. The PTP TC unit 42 makes the RRH 4 operate in a transparent mode (TC). That is, the PTP TC unit 42 calculates a residence time of the PTP message in the RRH 4.

The PTP slave unit 43 as the PTP slave transmits and receives PTP messages to and from the PTP master (BBU 3) (procedure in FIG. 1), and obtains PTP time information. The delay correcting unit 44 is used as a First-in First-out (FIFO), or fluctuation absorbing buffer for CPRI transmission line delay correction. The delay correcting unit 44 absorbs fluctuations of a clock of the CPRI transmission line and a reference clock and reference timing within the RRH 4 using the PTP time information (offset). The RF unit 45 transmits and receives radio signals to and from a radio terminal (not illustrated).

The CPRI terminating unit 46 is in charge of a CPRI interface (RE interface) with the RRH 4 in the following stage. The RRH 4 further includes the PTP relay unit 47. The PTP relay unit 47 is in charge of operation as a PTP “relay” node described in the first embodiment. The PTP relay unit 47 is an example of a “control unit.”

Incidentally, as an example, a circuit (hardware) operating as the CPRI terminating unit 41, the CPRI terminating unit 46, the delay correcting unit 44, and the RF unit 45 is implemented in the RRH 4. The circuit is formed by a semiconductor device or a combination of a semiconductor device and an electric and electronic circuit as described above. In addition, as an example, a combination of a processor (a CPU, a DSP, or the like) and a memory (a main storage device and an auxiliary storage device) is implemented in the RRH 4. The processor operates as the PTP TC unit 42, the PTP slave unit 43, and the PTP relay unit 47 by executing a program. However, at least one or more of the PTP IC unit 42, the PTP slave unit 43, and the PTP relay unit 47 may be implemented by hardware.

As illustrated in FIG. 29, the RRH 4 (RRH #N) in the last stage among the plurality of RRHs 4 operates as the slave with respect to the PTP master (BBU 3). Therefore, in the RRH #N, the PTP TC unit 42 and the PTP slave unit 43 perform operation as the PTP slave, and perform time synchronization based on PTP. In FIG. 29, a symbol “S” denoting the PTP slave with respect to the PTP master “M” of the BBU #1 is illustrated in the block of the PTP slave unit 43. On the other hand, in each of the RRHs 4 (RRHs #1, #2, and #N-1) between the BBU 3 and the RRH #N, the PTP TC units 42 and the PTP relay units 47 perform operation as PTP relay nodes, and achieve time synchronization with the PTP master.

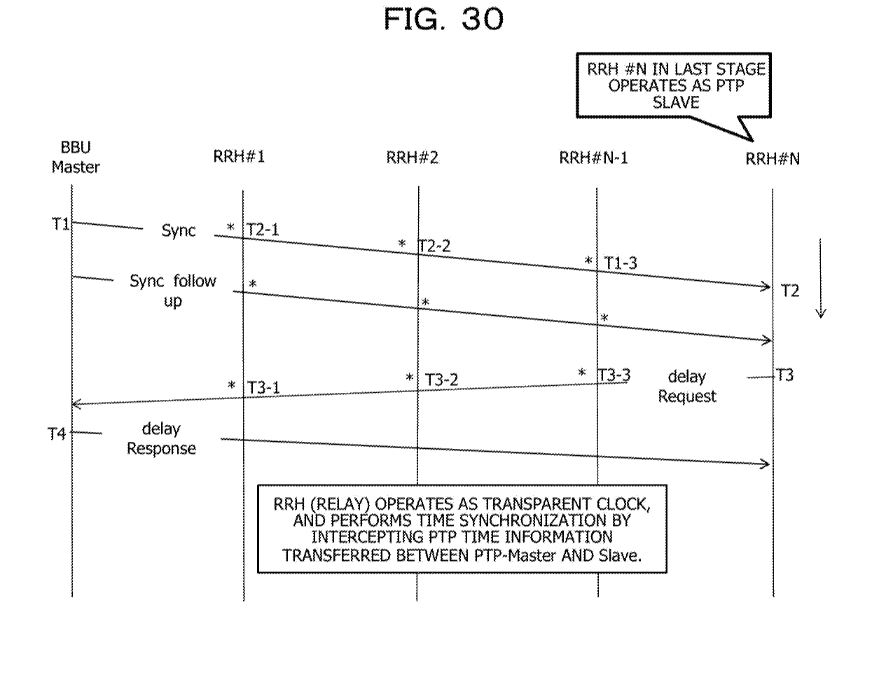

FIG. 30 is a sequence diagram illustrating an example of operation of the second embodiment. As illustrated in FIG. 30, the BBU 3 operates as the PTP master, and the RRH #N operates as the slave. The RRH #1, the RRH #2, and the RRH #N-1 located in between operate as transparent clocks, while performing time synchronization by intercepting the PTP time information transmitted and received between the PTP master and the slave. Each of the RRH #1, the RRH #2, and the RRH #N-1 performs processing as illustrated in FIG. 25. On the other hand, the RRH #N performs processing similar to the processing illustrated in FIG. 26. Because each RRH 4 thus performs time synchronization based on PTP with the BBU 3, the output timing of radio signals in each RRH 4 can be made uniform.

The second embodiment has the following advantages. Suppose that in a case where a plurality of RRHs 4 are cascaded to a BBU 3, PTP messages are transmitted and received in the transparent mode with the BBU 3 as the PTP master. In this case, the PTP messages are sequentially transmitted and received between the BBU 3 and each of the RRHs 4 as illustrated in FIG. 1. There is thus a problem of taking time to complete PTP time synchronization of all of the RRHs 4.

On the other hand, in the second embodiment, during the transmission and reception of the PTP messages between the BBU 3 (PTP master) and the RRH 4 (slave) in the last stage, each of the RRHs 4 located between the BBU 3 and the RRH 4 in the last stage also performs time synchronization using the PTP messages. It is thereby possible to shorten time taken for the plurality of RRHs 4 to achieve time synchronization.

It is to be noted that while an example in which BBUs 3 and RRHs 4 are “relay nodes” has been described in the foregoing first and second embodiments, the “relay nodes” include devices and nodes other than base station devices such as the BBUs 3 and the RRHs 4. The configurations of the foregoing embodiments can be combined with each other as appropriate.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention. For example, the steps recited in any of the process or method descriptions may be executed in any order and are not limited to the order presented.

What is claimed is:

1. A communication apparatus for relaying a time synchronizing signal between a master node and a slave node that perform time synchronization using PTP (Precision Time Protocol), the communication apparatus comprising:
a memory; and
a processor coupled to the memory and configured to
execute a first process, the first process including, when the time synchronizing signal relayed by the communication apparatus is a first time synchronizing signal addressed to the slave node, storing a first time, the first time being a time of the communication apparatus at a point in time that the communication apparatus receives the first time synchronizing signal,
execute a second process, the second process including obtaining a second time, the second time being a time of the master node at a point in time that the first time synchronizing signal is transmitted from the master node to the slave node from the first time synchronizing signal or a second time synchronizing signal transmitted from the master node to the slave node after the first time synchronizing signal,
execute a third process, the third process including obtaining an amount of offset, the amount of offset being a difference between a reference time of the master node and a reference time of the communication apparatus, using the first time as a time of the slave node in a time synchronizing algorithm of the PTP, and using the second time as the time of the master node, and
execute a fourth process, the fourth process including correcting the reference time of the communication apparatus on a basis of the obtained amount of offset.

2. The communication apparatus according to claim 1,
wherein the processor is configured to
execute a fifth process, the fifth process including storing a third time, the third time being a time of the communication apparatus at a point in time that the communication apparatus transfers, to the master node, a third time synchronizing signal transmitted to the master node by the slave node that has received the first time synchronizing signal, and
execute a sixth process, the sixth process including obtaining a fourth time, the fourth time being a time of the master node at a point in time that the master node receives the third time synchronizing signal, from a fourth time synchronizing signal transmitted to the slave node by the master node, and
wherein the third process includes obtaining the amount of offset, the amount of offset being the difference between the reference time of the master node and the reference time of the communication apparatus, using the first time and the third time as times of the slave node in the time synchronizing algorithm of the PTP, and using the second time and the fourth time as times of the master node.

3. The communication apparatus according to claim 1,
wherein each of the first to fourth time synchronizing signals includes a region in which a residence time in each communication apparatus relaying each of the first to fourth time synchronizing signals is added,
wherein the processor is configured to
execute a seventh process, the seventh process including storing, as a first residence time, the residence time in the region at the time of reception of the first time synchronizing signal,
execute an eighth process, the eighth process including storing, as a first period, the residence time in the region at the time of transfer of the third time synchronizing signal, and
execute a ninth process, the ninth process including obtaining a second residence time by subtracting the first period from a second period, the second period being a sum total of residence times in an interval from the slave node to the master node, and the second period being included in the region at a time of reception of the fourth time synchronizing signal, and
wherein the third process includes considering the first residence time and the second residence time when obtaining the amount of offset.

4. The communication apparatus according to claim 1,
wherein the communication apparatus is a node in a ring network, and is adjacent, in the ring network, to a first node serving as the slave node among other nodes in the ring network, and
wherein the processor is configured to
identify a location of a fault in the ring network on a basis of control information received at a time of the fault in the ring network, and
send, to the master node, an instruction to change a destination of the time synchronizing signal addressed to the slave node from the first node to a second node among the plurality of nodes, the second node being determined on a basis of the location of the fault.

5. The communication apparatus according to claim 4,
wherein the processor is configured to
execute a process of sending an instruction to operate as a slave node to the second node, and
execute a process of transmitting, to the first node, an instruction to transfer the time synchronizing signal from the master node to the second node,

6. The communication apparatus according to claim 4,
wherein the processor is configured to
when a node discoupled from the first node due to occurrence of the fault in the ring network and a node coupled to the first node even after the occurrence of the fault in the ring network are determined as the second node, instruct the node discoupled from the first node to transmit a health check signal that is to arrive at the relay node via the first node with reception of the time synchronizing signal from the master node as a trigger.

7. The communication apparatus according to claim 6,
wherein the processor is configured to
transmit, to the master node, an instruction to change the destination of the time synchronizing signal addressed to the slave node from the second node to the first node when the health check signal is received.

8. The communication apparatus according to claim 7,
wherein the processor is configured to
send an instruction to operate as a slave node to the first node, and transmit, to the second node, an instruction to transfer the time synchronizing signal from the master node to the first node.

9. A time synchronizing method executed by a processor configured to relay a time synchronizing signal between a master node and a slave node that perform time synchronization using PTP (Precision Time Protocol), the method comprising:
when the time synchronizing signal relayed by the communication apparatus is a first time synchronizing signal addressed to the slave node, storing a first time, the first time being a time of the communication apparatus at a point in time that the communication apparatus receives the first time synchronizing signal,
obtaining a second time, the second time being a time of the master node at a point in time that the first time synchronizing signal is transmitted from the master node to the slave node, from the first time synchronizing signal or a second time synchronizing signal transmitted from the master node to the slave node after the first time synchronizing signal,
obtaining an amount of offset, the amount of offset being a difference between a reference time of the master node and a reference time of the communication apparatus, using the first time as a time of the slave node in a time synchronizing algorithm of the PTP, and using the second time as the time of the master node, and
correcting the reference time of the communication apparatus on a basis of the obtained amount of offset.

10. A non-transitory computer-readable storage medium storing a program that causes a communication apparatus to execute a process, the communication apparatus being configured to relay a time synchronizing signal between a master node and a slave node that perform time synchronization using PTP (Precision Time Protocol), the process comprising:
when the time synchronizing signal relayed by the communication apparatus is a first time synchronizing signal addressed to the slave node, storing a first time, the first time being a time of the communication apparatus at, a point in time that the communication apparatus receives the first time synchronizing signal,
obtaining a second time, the second time being a time of the master node at a point in time that the first time synchronizing signal is transmitted from the master node to the slave node, from the first time synchronizing signal or a second time synchronizing signal transmitted from the master node to the slave node after the first time synchronizing signal,
obtaining an amount of offset, the amount of offset being a difference between a reference time of the master node and a reference time of the communication apparatus, using the first time as a time of the slave node in a time synchronizing algorithm of the PTP, and using the second time as the time of the master node, and
correcting the reference time of the communication apparatus on a basis of the obtained amount of offset.
